(19) United States
(12) Patent Application Publication
(10) Pub. No.: US 2020/0276861 A1
(43) Pub. Date: Sep. 3, 2020

(54) WHEEL COMPRISING A NON-PNEUMATIC TIRE

(71) Applicants: Ronald H. THOMPSON, Greenville, SC (US); Jeremie ZUCHOSKI, Sherbrooke (CA)

(72) Inventors: Ronald H. THOMPSON, Greenville, SC (US); Jeremie ZUCHOSKI, Sherbrooke (CA)

(21) Appl. No.: 16/063,100

(22) PCT Filed: Dec. 16, 2016
(86) PCT No.: PCT/US2016/067289

§ 371 Date: Jun. 15, 2018

Related U.S. Application Data
(60) Provisional application No. 62/268,243, filed on Dec. 16, 2015.

(51) Int. Cl. B60B 9/26; B60C 7/14

(52) U.S. Cl. CPC B60B 9/26; B60C 2200/14; B60C 2007/146; B60C 7/14

(57) ABSTRACT

A wheel for a vehicle (e.g., an all-terrain vehicle (ATV), a construction vehicle, etc.) or other device, in which the wheel comprises a non-pneumatic tire and may be designed to enhance its use and performance and/or use and performance of the vehicle or other device, including, for example, to improve a shock-absorbing capability of the wheel, to improve a lateral stability of the vehicle or other device, and/or to enhance other aspects of its use and performance and/or that of the vehicle or other device.

### CROSS-REFERENCE TO RELATED APPLICATION

This application claims priority from U.S. Provisional Patent Application 62/268,243 filed on Dec. 16, 2015 and hereby incorporated by reference herein.

### FIELD

The invention relates generally to wheels comprising non-pneumatic tires (NPTs), such as for vehicles (e.g., all-terrain vehicles (ATVs); industrial vehicles such as construction vehicles; agricultural vehicles; automobiles and other road vehicles; etc.) and/or other devices.

### BACKGROUND

Wheels for vehicles and other devices may comprise non-pneumatic tires (sometimes referred to as NPTs) instead of pneumatic tires.

Pneumatic tires have a commanding market share due to several virtues. For example, a pneumatic tire may offer high vertical compliance and the ability to have a large deflection before impact occurs with the wheel, which is usually metallic. The pneumatic tire may develop a large contact area, which is efficient for transferring tangential and longitudinal forces from the tire/road contact area to the vehicle. The pneumatic tire is also able to envelop obstacles. Added to these is the fact that the pneumatic tire, with over 100 years of refinement, is a mature product and therefore inexpensive to produce.

In particular, the high compliance and potential for large deflection are major pneumatic tire virtues in the off-road vehicle market. For example, in the ATV industry, a 650 mm (26″) outer diameter tire can be mounted to a 12″ diameter rim. When inflated to 0.08 MPa (12 psi), a design load of 240 kgf (kilogram-force) is reached with 20 mm of deflection, for a vertical stiffness of only 20 kgf/mm. A total deflection of 125 mm is possible, before the tire is pinched between the ground and the rim. Thus, a ratio between the tire deflection and the tire radius is 120 mm to 325 mm, or 0.38:1. The tire deflection is almost 40% the tire radius.

Certain vehicles like some ATVs may be capable of speeds in excess of 100 kph. Even at speeds above 50 kph, impacts with rocks or other hard obstacles result in an imposed tire deflection. The suspension cannot react to essentially an instantaneous impact. Thus, the ability of the tire to locally deform and envelop such obstacles is a highly desired trait.

Non-pneumatic tires are used in certain applications. They are sometimes used in highly aggressive environments where flats are a problem for pneumatic tires. NPTs are not inflated and have no gas-filled bladder like a pneumatic tire. Examples of use for NPTs would include certain off-road usage like construction job sites and waste management sites. In these sites, NPT disadvantages are outweighed by their damage tolerance.

Yet, this damage tolerance usually comes with a trade-off. With reference to the pneumatic tire virtues just mentioned, a non-pneumatic tire may suffer in terms of its ability to sustain a large vertical deflection, and/or to develop a large contact area. Additionally, NPTs may be more complex and expensive to manufacture.

For these and other reasons, there is a need to improve wheels comprising non-pneumatic tires.

### SUMMARY

According to various aspects of the invention, there is provided a wheel for a vehicle or other device, in which the wheel comprises a non-pneumatic tire and may be designed to enhance its use and performance and/or use and performance of the vehicle or other device, including, for example, to improve a shock-absorbing capability of the wheel, to improve a lateral stability of the vehicle or other device, and/or to enhance other aspects of its use and performance and/or that of the vehicle or other device.

For example, according to an aspect of the invention, there is provided a wheel comprising a non-pneumatic tire. The non-pneumatic tire comprises: an annular beam configured to deflect at a contact patch of the non-pneumatic tire; and an annular support disposed radially inwardly of the annular beam and configured to resiliently deform as the wheel engages the ground. A ratio of a mass of the wheel over an outer diameter of the wheel normalized by a width of the wheel is no more than 0.0005 kg/mm².

According to an aspect of the invention, there is provided a wheel comprising a non-pneumatic tire. The non-pneumatic tire comprises: an annular beam configured to deflect at a contact patch of the non-pneumatic tire; and an annular support disposed radially inwardly of the annular beam and configured to resiliently deform as the wheel engages the ground. A ratio of a radial stiffness of the wheel over an outer diameter of the wheel normalized by a width of the wheel is between 0.0001 kgf/mm³ and 0.0002 kgf/mm³.

According to an aspect of the invention, there is provided a wheel comprising a non-pneumatic tire. The non-pneumatic tire comprises: an annular beam configured to deflect at a contact patch of the non-pneumatic tire; and an annular support disposed radially inwardly of the annular beam and configured to resiliently deform as the wheel engages the ground. A radial stiffness of the wheel is no more than 15 kgf/mm.

According to an aspect of the invention, there is provided a wheel comprising a non-pneumatic tire. The non-pneumatic tire comprises: an annular beam configured to deflect at a contact patch of the non-pneumatic tire; and a plurality of spokes disposed radially inwardly of the annular beam and configured to resiliently deform as the wheel engages the ground. The wheel comprises a hub disposed radially inwardly of the spokes. A ratio of a volume occupied by the spokes over a volume bounded by the annular beam and the hub is no more than 15%.

According to an aspect of the invention, there is provided a wheel comprising a non-pneumatic tire. The non-pneumatic tire comprises: an annular beam configured to deflect at a contact patch of the non-pneumatic tire; and an annular support disposed radially inwardly of the annular beam and configured to resiliently deform as the wheel engages the ground. The wheel comprises a hub disposed radially inwardly of the annular support and resiliently deformable as the wheel engages the ground.

According to an aspect of the invention, there is provided a wheel comprising a non-pneumatic tire. The non-pneumatic tire comprises: an annular beam configured to deflect at a contact patch of the non-pneumatic tire; and an annular support disposed radially inwardly of the annular beam and configured to resiliently deform as the wheel engages the ground. A lateral stiffness of the wheel is greater than a radial stiffness of the wheel.

According to an aspect of the invention, there is provided a wheel comprising a non-pneumatic tire. The non-pneumatic tire comprises: an annular beam configured to deflect at a contact patch of the non-pneumatic tire; and an annular support disposed radially inwardly of the annular beam and configured to resiliently deform as the wheel engages the ground. The wheel comprises a hub disposed radially inwardly of the annular support. The wheel comprises a plurality of modules selectively attachable to and detachable from one another.

According to an aspect of the invention, there is provided a wheel comprising a non-pneumatic tire. The non-pneumatic tire comprises: an annular beam configured to deflect at a contact patch of the non-pneumatic tire; and an annular support disposed radially inwardly of the annular beam and configured to resiliently deform as the wheel engages the ground. The wheel comprises a hub disposed radially inwardly of the annular support. The non-pneumatic tire and the hub are selectively attachable to and detachable from one another.

According to an aspect of the invention, there is provided a wheel comprising a non-pneumatic tire. The non-pneumatic tire comprises: an annular beam configured to deflect at a contact patch of the non-pneumatic tire; and a plurality of spokes disposed radially inwardly of the annular beam and configured to resiliently deform as the wheel engages the ground. The wheel comprises a damping element configure to dissipate energy when impacted.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIGS. 1A and 1B show an example of a vehicle comprising wheels in accordance with an embodiment of the invention;

FIG. 2A shows a perspective view of a wheel;

FIG. 2B shows a close-up view of part of a non-pneumatic tire of the wheel;

FIG. 3 shows a cross-sectional view of the wheel;

FIGS. 4 to 7 show representations of the wheel in different conditions;

FIG. 8 shows an example of an embodiment in which a hub of the wheel is resiliently deformable;

FIGS. 9 and 10 show representations of the wheel of FIG. 8 in different conditions;

FIGS. 11 and 12 show charts that relate radial loading and deflection for the wheel of FIG. 8;

FIG. 13 shows deformed and undeformed states of the wheel of FIG. 8 in various conditions;

FIG. 14 shows a variant of the vehicle;

FIG. 15 shows lateral loading on the wheels of the vehicle during a maneuver;

FIG. 16 shows a lateral load on the wheel;

FIG. 17 shows a cornering load on the wheel;

FIG. 18 shows an example of a test for determining a lateral stiffness of the wheel;

FIGS. 19 to 21 show an example of an embodiment in which the wheel is modular;

FIG. 22 shows a plurality of different hubs to which the non-pneumatic tire may be fitted;

FIG. 23 shows an attachment mechanism of the wheel of FIGS. 19 to 21;

FIG. 24 shows an example of an embodiment in which the non-pneumatic tire and the hub are made integrally as one piece;

FIG. 25 shows an example of an embodiment in which the wheel comprises a damping mechanism;

FIG. 26 shows an example of an embodiment in which the annular beam comprises a reinforcing layer;

FIG. 27 shows an example of an embodiment of the reinforcing layer;

FIG. 28 shows an example of another embodiment of the reinforcing layer;

FIG. 29 shows an example of an embodiment in which a thickness of the annular beam is increased;

FIG. 30 shows an example of another vehicle comprising wheels in accordance with another embodiment of the invention;

FIG. 31 shows a wheel of the vehicle of FIG. 30; and

FIG. 32 shows an example of another vehicle comprising wheels in accordance with another embodiment of the invention.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

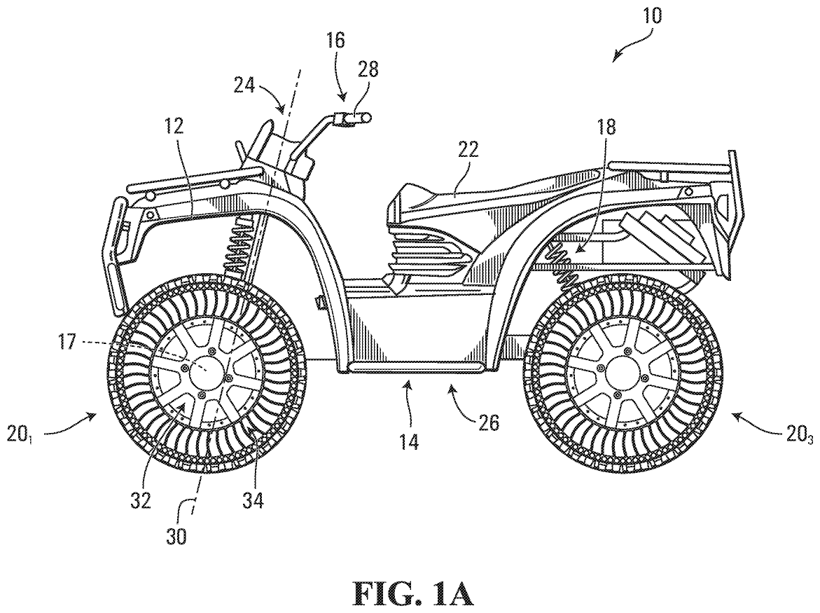

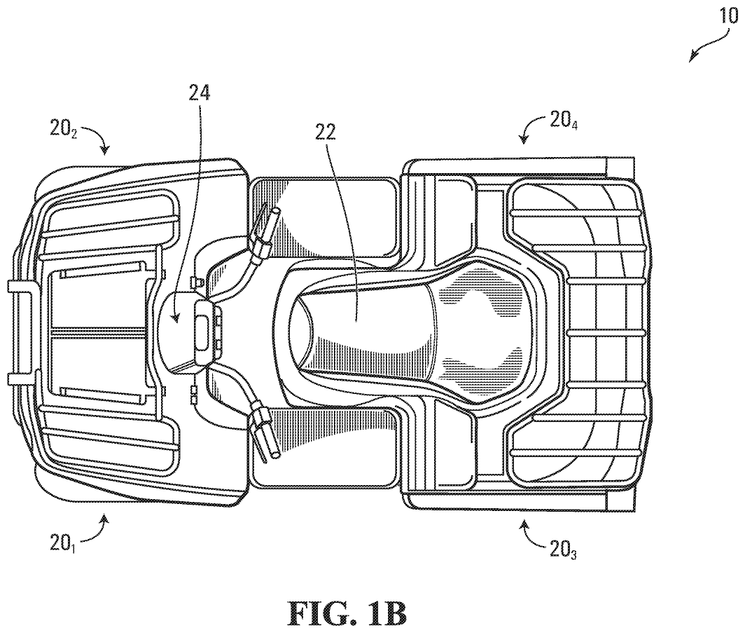

FIGS. 1A and 1B show an example of a vehicle 10 comprising wheels 20₁-20₄ in accordance with an embodiment of the invention. In this embodiment, the vehicle 10 is an all-terrain vehicle (ATV). The ATV 10 is a small open vehicle designed to travel off-road on a variety of terrains, including roadless rugged terrain, for recreational, utility and/or other purposes. In this example, the ATV 10 comprises a frame 12, a powertrain 14, a steering system 16, a suspension 18, the wheels 20₁-20₄, a seat 22, and a user interface 24, which enable a user of the ATV to ride the ATV 10 on the ground. The ATV 10 has a longitudinal direction, a widthwise direction, and a height direction.

In this embodiment, as further discussed later, the wheels 20₁-20₄ are non-pneumatic (i.e., airless) and may be designed to enhance their use and performance and/or use and performance of the ATV 10, including, for example, to improve a shock-absorbing capability of the wheels 20₁-20₄, to improve a lateral stability of the ATV 10, and/or to enhance other aspects of their use and performance and/or that of the ATV 10.

The powertrain 14 is configured for generating motive power and transmitting motive power to respective ones of the wheels 20₁-20₄ to propel the ATV 10 on the ground. To that end, the powertrain 14 comprises a prime mover 26, which is a source of motive power that comprises one or more motors. For example, in this embodiment, the prime mover 26 comprises an internal combustion engine. In other embodiments, the prime mover 26 may comprise another type of motor (e.g., an electric motor) or a combination of different types of motor (e.g., an internal combustion engine and an electric motor). The prime mover 26 is in a driving relationship with one or more of the wheels 20₁-20₄. That is, the powertrain 14 transmits motive power generated by the prime mover 26 to one or more of the wheels 20₁-20₄ (e.g., via a transmission and/or a differential) in order to drive (i.e., impart motion to) these one or more of the wheels 20₁-20₄.

The steering system 16 is configured to enable the user to steer the ATV 10 on the ground. To that end, the steering system 16 comprises a steering device 28 that is operable by the user to direct the ATV 10 along a desired course on the ground. In this embodiment, the steering device 28 comprises handlebars. The steering device 28 may comprise a steering wheel or any other steering component that can be operated by the user to steer the ATV 10 in other embodiments. The steering system 16 responds to the user interacting with the steering device 28 by turning respective ones of the wheels 20₁-20₄ to change their orientation relative to the frame 12 of the ATV 10 in order to cause the ATV 10 to move in a desired direction. In this example, front ones of the wheels 20₁-20₄ are turnable in response to input of the user at the steering device 28 to change their orientation relative to the frame 12 of the ATV 10 in order to steer the ATV 10 on the ground. More particularly, in this example, each of the front ones of the wheels 20₁-20₄ is pivotable about a steering axis 30 of the ATV 10 in response to input of the user at the steering device 10 in order to steer the ATV 10 on the ground. Rear ones of the wheels 20₁-20₄ are not turned relative to the frame 12 of the ATV 10 by the steering system 16.

The suspension 18 is connected between the frame 12 and the wheels 20₁-20₄ to allow relative motion between the frame 12 and the wheels 20₁-20₄ as the ATV 10 travels on the ground. For example, the suspension 18 enhances handling of the ATV 10 on the ground by absorbing shocks and helping to maintain traction between the wheels 20₁-20₄ and the ground. The suspension 18 may comprise an arrangement of springs and dampers. A spring may be a coil spring, a leaf spring, a gas spring (e.g., an air spring), or any other elastic object used to store mechanical energy. A damper (also sometimes referred to as a “shock absorber”) may be a fluidic damper (e.g., a pneumatic damper, a hydraulic damper, etc.), a magnetic damper, or any other object which absorbs or dissipates kinetic energy to decrease oscillations. In some cases, a single device may itself constitute both a spring and a damper (e.g., a hydropneumatic, hydrolastic, or hydragas suspension device).

In this embodiment, the seat 22 is a straddle seat and the ATV 10 is usable by a single person such that the seat 22 accommodates only that person driving the ATV 10. In other embodiments, the seat 22 may be another type of seat, and/or the ATV 10 may be usable by two individuals, namely one person driving the ATV 10 and a passenger, such that the seat 22 may accommodate both of these individuals (e.g., behind one another or side-by-side) or the ATV 10 may comprise an additional seat for the passenger. For example, in other embodiments, the ATV 10 may be a side-by-side ATV, sometimes referred to as a “utility terrain vehicle” or “utility task vehicle” (UTV).

The user interface 24 allows the user to interact with the ATV 10. More particularly, the user interface 24 comprises an accelerator, a brake control, and the steering device 28 that are operated by the user to control motion of the ATV 10 on the ground. The user interface 24 also comprises an instrument panel (e.g., a dashboard) which provides indicators (e.g., a speedometer indicator, a tachometer indicator, etc.) to convey information to the user.

The wheels 20₁-20₄ engage the ground to provide traction to the ATV 10. More particularly, in this example, the front ones of the wheels 20₁-20₄ provide front traction to the ATV 10 while the rear ones of the wheels 20₁-20₄ provide rear traction to the ATV 10.

Each wheel 20ᵢ comprises a non-pneumatic tire 34 for contacting the ground and a hub 32 for connecting the wheel 20ᵢ to an axle 17 of the ATV 10. The non-pneumatic tire 34 is a compliant wheel structure that is not supported by gas (e.g., air) pressure and that is resiliently deformable (i.e., changeable in configuration) as the wheel 20ᵢ contacts the ground.

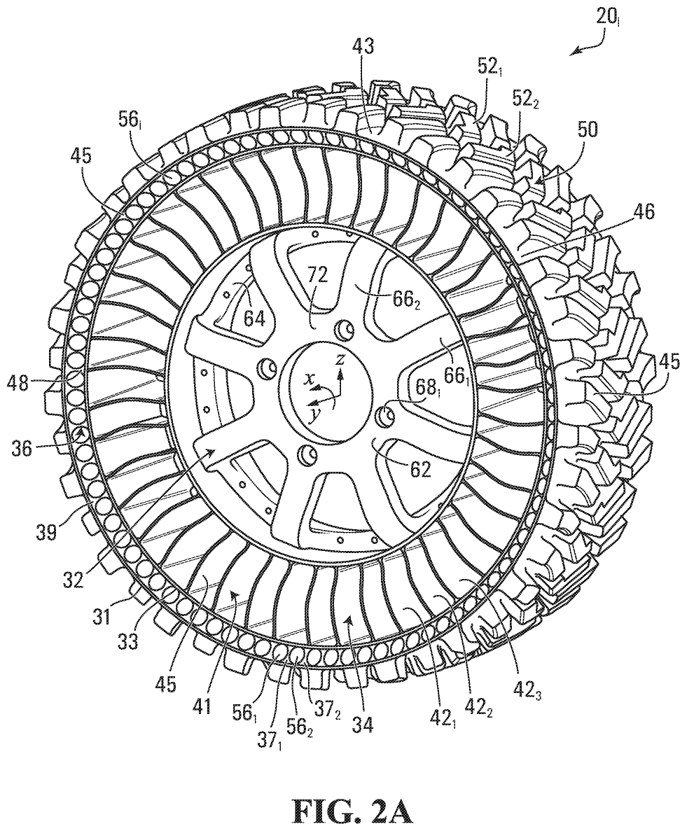

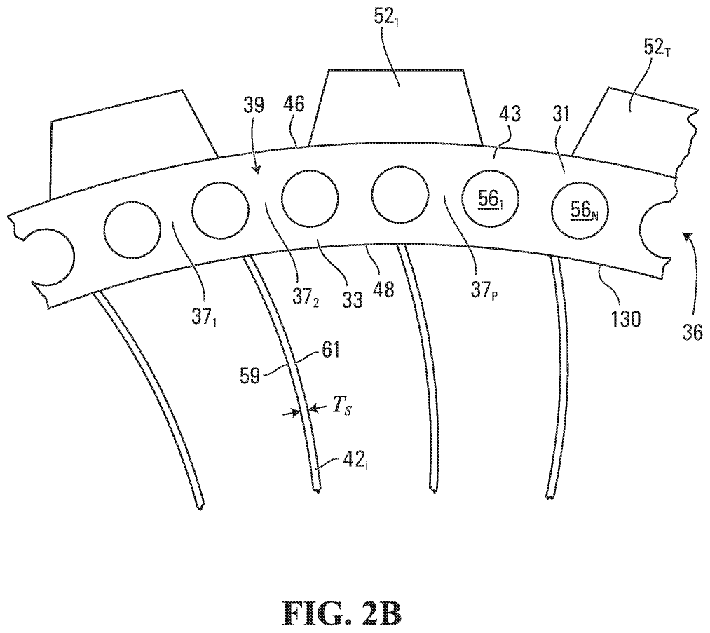

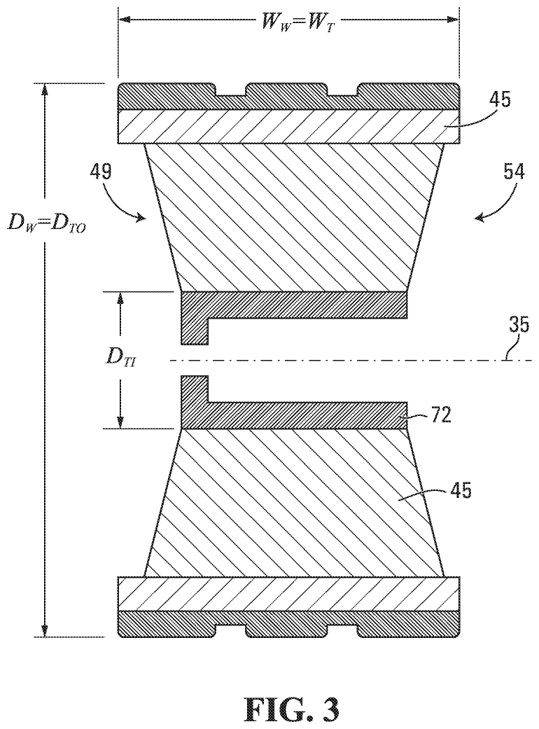

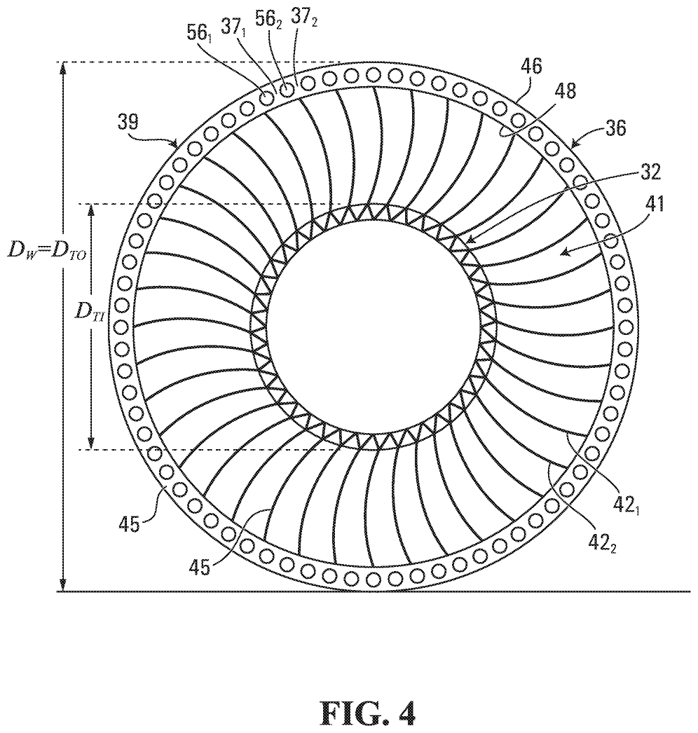

With additional reference to FIGS. 2A to 5, the wheel 20ᵢ has an axial direction defined by an axis of rotation 35 of the wheel 20ᵢ (also referred to as a “Y” direction), a radial direction (also referred to as a “Z” direction), and a circumferential direction (also referred to as a “X” direction). The wheel 20ᵢ has an outer diameter D_{W} and a width W_{W}. It comprises an inboard lateral side 54 for facing a center of the ATV 10 in the widthwise direction of the ATV 10 and an outboard lateral side 49 opposite the inboard lateral side 54. As shown in FIG. 4, when it is in contact with the ground, the wheel 20ᵢ has an area of contact 25 with the ground, which may be referred to as a “contact patch” of the wheel 20ᵢ with the ground. The contact patch 25 of the wheel 20ᵢ, which is a contact interface between the non-pneumatic tire 34 and the ground, has a dimension L_{C}, referred to as a “length”, in the circumferential direction of the wheel 20ᵢ and a dimension W_{C}, referred to as a “width”, in the axial direction of the wheel 20ᵢ.

The non-pneumatic tire 34 comprises an annular beam 36 and an annular support 41 that is disposed between the annular beam 36 and the hub 32 of the wheel 20ᵢ and configured to support loading on the wheel 20ᵢ as the wheel 20ᵢ engages the ground. In this embodiment, the non-pneumatic tire 34 is tension-based such that the annular support 41 is configured to support the loading on the wheel 20ᵢ by tension. That is, under the loading on the wheel 20ᵢ, the annular support 41 is resiliently deformable such that a lower portion 27 of the annular support 41 between the axis of rotation 35 of the wheel 20ᵢ and the contact patch 25 of the wheel 20ᵢ is compressed (e.g., with little reaction force vertically) and an upper portion 29 of the annular support 41 above the axis of rotation 35 of the wheel 20ᵢ is in tension to support the loading.

The annular beam 36 of the tire 34 is configured to deflect under the loading on the wheel 20ᵢ at the contact patch 25 of the wheel 20ᵢ with the ground. For instance, the annular beam 36 functions like a beam in transverse deflection. An outer peripheral extent 46 of the annular beam 36 and an inner peripheral extent 48 of the annular beam 36 deflect at the contact patch 25 of the wheel 20ᵢ under the loading on the wheel 20ᵢ. In this embodiment, the annular beam 36 is configured to deflect such that it applies a homogeneous contact pressure along the length L_{C} of the contact patch 25 of the wheel 20ᵢ with the ground.

More particularly, in this embodiment, the annular beam 36 comprises a shear band 39 configured to deflect predominantly by shearing at the contact patch 25 under the loading on the wheel 20ᵢ. That is, under the loading on the wheel 20ᵢ, the shear band 39 deflects significantly more by shearing than by bending at the contact patch 25. The shear band 39 is thus configured such that, at a center of the contact patch 25 of the wheel 20ᵢ in the circumferential direction of the wheel 20ᵢ, a shear deflection of the shear band 39 is significantly greater than a bending deflection of the shear band 39. For example, in some embodiments, at the center of the contact patch 25 of the wheel 20ᵢ in the circumferential direction of the wheel 20ᵢ, a ratio of the shear deflection of the shear band 39 over the bending deflection of the shear band 39 may be at least 1.2, in some cases at least 1.5, in some cases at least 2, in some cases at least 3, and in some cases even more (e.g., 4 or more). For instance, in some embodiments, the annular beam 36 may be designed based on principles discussed in U.S. Patent Application Publication 2014/0367007, which is hereby incorporated by reference herein, in order to achieve the homogeneous contact pressure along the length L_{C} of the contact patch 25 of the wheel 20ᵢ with the ground.

In this example of implementation, the shear band 39 comprises an outer rim 31, an inner rim 33, and a plurality of openings 56₁-56_{N} between the outer rim 31 and the inner rim 33. The shear band 39 comprises a plurality of interconnecting members 37₁-37_{P} that extend between the outer rim 31 and the inner rim 33 and are disposed between respective ones of the openings 56₁-56_{N}. The interconnecting members 37₁-37_{P} may be referred to as “webs” such that the shear band 39 may be viewed as being “web-like” or “webbing”. The shear band 39, including the openings 56₁-56_{N} and the interconnecting members 37₁-37_{P}, may be arranged in any other suitable way in other embodiments.

The openings 56₁-56_{N} of the shear band 39 help the shear band 39 to deflect predominantly by shearing at the contact patch 25 under the loading on the wheel 20ᵢ. In this embodiment, the openings 56₁-56_{N} extend from the inboard lateral side 54 to the outboard lateral side 49 of the tire 34. That is, the openings 56₁-56_{N} extend laterally though the shear band 39 in the axial direction of the wheel 20ᵢ. The openings 56₁-56_{N} may extend laterally without reaching the inboard lateral side 54 and/or the outboard lateral side 49 of the tire 34 in other embodiments. The openings 56₁-56_{N} may have any suitable shape. In this example, a cross-section of each of the openings 56₁-56_{N} is circular. The cross-section of each of the openings 56₁-56_{N} may be shaped differently in other examples (e.g., polygonal, partly curved and partly straight, etc.). In some cases, different ones of the openings 56₁-56_{N} may have different shapes. In some cases, the cross-section of each of the openings 56₁-56_{N} may vary in the axial direction of the wheel 20ᵢ. For instance, in some embodiments, the openings 56₁-56_{N} may be tapered in the axial direction of the wheel 20ᵢ such that their cross-section decreases inwardly axially (e.g., to help minimize debris accumulation within the openings 56₁-56_{N}).

In this embodiment, the tire 34 comprises a tread 50 for enhancing traction between the tire 34 and the ground. The tread 50 is disposed about the outer peripheral extent 46 of the annular beam 36, in this case about the outer rim 31 of the shear band 39. More particularly, in this example the tread 50 comprises a tread base 43 that is at the outer peripheral extent 46 of the annular beam 36 and a plurality of tread projections 52₁-52_{T} that project from the tread base 52. The tread 50 may be implemented in any other suitable way in other embodiments (e.g., may comprise a plurality of tread recesses, etc.).

The annular support 41 is configured to support the loading on the wheel 20ᵢ as the wheel 20ᵢ engages the ground. As mentioned above, in this embodiment, the annular support 41 is configured to support the loading on the wheel 20ᵢ by tension. More particularly, in this embodiment, the annular support 41 comprises a plurality of support members 42₁-42_{T} that are distributed around the tire 34 and resiliently deformable such that, under the loading on the wheel 20ᵢ, lower ones of the support members 42₁-42_{T} in the lower portion 27 of the annular support 41 (between the axis of rotation 35 of the wheel 20ᵢ and the contact patch 25 of the wheel 20ᵢ) are compressed and bend while upper ones of the support members 42₁-42_{T} in the upper portion 29 of the annular support 41 (above the axis of rotation 35 of the wheel 20ᵢ) are tensioned to support the loading. As they support load by tension when in the upper portion 29 of the annular support 41, the support members 42₁-42_{T} may be referred to as “tensile” members.

In this embodiment, the support members 42₁-42_{T} are elongated and extend from the annular beam 36 towards the hub 32 generally in the radial direction of the wheel 20ᵢ. In that sense, the support members 42₁-42_{T} may be referred to as “spokes” and the annular support 41 may be referred to as a “spoked” support.

More particularly, in this embodiment, the inner peripheral extent 48 of the annular beam 36 is an inner peripheral surface of the annular beam 36 and each spoke 42ᵢ extends from the inner peripheral surface 48 of the annular beam 36 towards the hub 32 generally in the radial direction of the wheel 20ᵢ and from a first lateral end 55 to a second lateral end 58 in the axial direction of the wheel 20ᵢ. In this case, the spoke 42ᵢ extends in the axial direction of the wheel 20ᵢ for at least a majority of a width W_{T} of the tire 34, which in this case corresponds to the width W_{W} of the wheel 20ᵢ. For instance, in some embodiments, the spoke 42ᵢ may extend in the axial direction of the wheel 20ᵢ for more than half, in some cases at least 60%, in some cases at least 80%, and in some cases an entirety of the width W_{T} of the tire 34. Moreover, the spoke 42ᵢ has a thickness T_{S} measured between a first surface face 59 and a second surface face 61 of the spoke 42ᵢ that is significantly less than a length and width of the spoke 42ᵢ.

When the wheel 20ᵢ is in contact with the ground and bears a load (e.g., part of a weight of the ATV 10), respective ones of the spokes 42₁-42^{T} that are disposed in the upper portion 29 of the spoked support 41 (i.e., above the axis of rotation 35 of the wheel 20ᵢ) are placed in tension while respective ones of the spokes 42₁-42_{T} that are disposed in the lower portion 27 of the spoked support 41 (i.e., adjacent the contact patch 25) are placed in compression. The spokes 42₁-42_{T} in the lower portion 27 of the spoked support 41 which are in compression bend in response to the load. Conversely, the spokes 42₁-42_{T} in the upper portion 29 of the spoked support 41 which are placed in tension support the load by tension.

The tire 34 has an inner diameter D_{TI} and an outer diameter D_{TO}, which in this case corresponds to the outer diameter D_{W} of the wheel 20ᵢ. A sectional height H_{T} of the tire 34 is half of a difference between the outer diameter D_{TO} and the inner diameter D_{TI} of the tire 34. The sectional height H_{T} of the tire may be significant in relation to the width W_{T} of the tire 34. In other words, an aspect ratio AR of the tire 34 corresponding to the sectional height H_{T} over the width W_{T} of the tire 34 may be relatively high. For instance, in some embodiments, the aspect ratio AR of the tire 34 may be at least 70%, in some cases at least 90%, in some cases at least 110%, and in some cases even more. Also, the inner diameter D_{TI} of the tire 34 may be significantly less than the outer diameter D_{TO} of the tire 34 as this may help for compliance of the wheel 20ᵢ. For example, in some embodiments, the inner diameter D_{TI} of the tire 34 may be no more than half of the outer diameter D_{TO} of the tire 34, in some cases less than half of the outer diameter D_{TO} of the tire 34, in some cases no more than 40% of the outer diameter D_{TO} of the tire 34, and in some cases even a smaller fraction of the outer diameter D_{TO} of the tire 34.

The hub 32 is disposed centrally of the tire 34 and connects the wheel 20ᵢ to the axle 17 of the ATV 10. In this embodiment, the hub 32 comprises an inner member 62, an outer member 64 radially outward of the inner member 62, and a plurality of arms 66₁-66_{A} joining the inner member 62 and the outer member 64. The inner member 62 comprises apertures 68₁-68_{A} defining a bolt pattern of the hub 32. The apertures 68₁-68_{A} allow a user to locate therein wheel studs (i.e., threaded fasteners) that typically project from a brake disk or a brake drum of the ATV 10. A lug nut 75 can be used to secure the hub 32 to each wheel stud in order to establish a fixed connection between the wheel 20ᵢ and the axle 17 of the ATV 10. The bolt pattern of the hub 32 (e.g., the number and/or positioning of apertures 68₁-68_{A} in the inner member 62) may be designed in any suitable way (e.g., dependent on the type, model and/or brand of the ATV 10 to which the hub 32 is designed to fit). The hub 32 may be implemented in any other suitable manner in other embodiments (e.g., it may have any other suitable shape or design).

The wheel 20ᵢ may be made up of one or more materials. The non-pneumatic tire 34 comprises a tire material 45 that makes up at least a substantial part (i.e., a substantial part or an entirety) of the tire 34. The hub 32 comprises a hub material 72 that makes up at least a substantial part of the hub 32. In some embodiments, the tire material 45 and the hub material 72 may be different materials. In other embodiments, the tire material 45 and the hub material 72 may be a common material (i.e., the same material).

In this embodiment, the tire material 45 constitutes at least part of the annular beam 36 and at least part of the spokes 42₁-42_{T}. Also, in this embodiment, the tire material 45 constitutes at least part of the tread 50. More particularly, in this embodiment, the tire material 45 constitutes at least a majority (e.g., a majority or an entirety) of the annular beam 36, the tread 50, and the spokes 42₁-42_{T}. In this example of implementation, the tire material 45 makes up an entirety of the tire 34, including the annular beam 36, the spokes 42₁-42_{T}, and the tread 50. The tire 34 is thus monolithically made of the tire material 45. In this example, therefore, the annular beam 36 is free of (i.e., without) a substantially inextensible reinforcing layer running in the circumferential direction of the wheel 20ᵢ (e.g., a layer of metal, composite (e.g., carbon fibers, other fibers), and/or another material that is substantially inextensible running in the circumferential direction of the wheel 20ᵢ). In that sense, the annular beam 36 may be said to be “unreinforced”.

The tire material 45 is elastomeric. For example, in this embodiment, the tire material 45 comprises a polyurethane (PU) elastomer. For instance, in some cases, the PU elastomer may be composed of a TDI pre-polymer, such as PET-95A, cured with MCDEA, commercially available from COIM. Other materials that may be suitable include using PET95-A or PET60D, cured with MOCA. Other materials available from Chemtura may also be suitable. These may include Adiprene E500X and E615X prepolymers, cured with C3LF or HQEE curative. Blends of the above prepolymers are also possible. Prepolymer C930 and C600, cured with C3LF or HQEE may also be suitable, as are blends of these prepolymers.

Polyurethanes that are terminated using MDI or TDI are possible, with ether and/or ester and/or polycaprolactone formulations, in addition to other curatives known in the cast polyurethane industry. Other suitable resilient, elastomeric materials would include thermoplastic materials, such as HYTREL co-polymer, from DuPont, or thermoplastic polyurethanes such as Elastollan, from BASF. Materials in the 95A to 60D hardness level may be particularly useful, such as Hytrel 5556 and Elastollan 98A. Some resilient thermoplastics, such as plasticized nylon blends, may also be used. The Zytel line of nylons from DuPont may be particularly useful. The tire material 45 may be any other suitable material in other embodiments.

In this embodiment, the tire material 45 may exhibit a non-linear stress vs. strain behavior. For instance, the tire material 45 may have a secant modulus that decreases with increasing strain of the tire material 45. The tire material 45 may have a high Young's modulus that is significantly greater than the secant modulus at 100% strain (a.k.a. “the 100% modulus”). Such a non-linear behavior of the tire material 45 may provide efficient load carrying during normal operation and enable impact loading and large local deflections without generating high stresses. For instance, the tire material 45 may allow the tire 34 to operate at a low strain rate (e.g., 2% to 5%) during normal operation yet simultaneously allow large strains (e.g., when the ATV 10 engages obstacles) without generating high stresses. This in turn may be helpful to minimize vehicle shock loading and enhance durability of the tire 34.

The tire 34 may comprise one or more additional materials in addition to the tire material 45 in other embodiments (e.g., different parts of the annular beam 36, different parts of the tread 50, and/or different parts of the spokes 42₁-42_{T} may be made of different materials). For example, in some embodiments, different parts of the annular beam 36, different parts of the tread 50, and/or different parts of the spokes 42₁-42_{T} may be made of different elastomers. As another example, in some embodiments, the annular beam 36 may comprise one or more substantially inextensible reinforcing layers running in the circumferential direction of the wheel 20ᵢ (e.g., one or more layers of metal, composite (e.g., carbon fibers, other fibers), and/or another material that is substantially inextensible running in the circumferential direction of the wheel 20ᵢ).

In this embodiment, the hub material 72 constitutes at least part of the inner member 62, the outer member 64, and the arms 66₁-66_{A} of the hub 32. More particularly, in this embodiment, the hub material 72 constitutes at least a majority (e.g., a majority or an entirety) of the inner member 62, the outer member 64, and the arms 66₁-66_{A}. In this example of implementation, the hub material 72 makes up an entirety of the hub 32.

In this example of implementation, the hub material 72 is polymeric. More particularly, in this example of implementation, the hub material 72 is elastomeric. For example, in this embodiment, the hub material 72 comprises a polyurethane (PU) elastomer. For instance, in some cases, the PU elastomer may be PET-95A commercially available from COIM, cured with MCDEA.

The hub material 72 may be any other suitable material in other embodiments. For example, in other embodiments, the hub material 72 may comprise a stiffer polyurethane material, such as COIM's PET75D cured with MOCA. In some embodiments, the hub material 72 may not be polymeric. For instance, in some embodiments, the hub material 72 may be metallic (e.g., steel, aluminum, etc.).

The hub 32 may comprise one or more additional materials in addition to the hub material 72 in other embodiments (e.g., different parts of the inner member 62, different parts of the outer member 64, and/or different parts of the arms 66₁-66_{A}may be made of different materials).

The wheel 20ᵢ may be manufactured in any suitable way. For example, in some embodiments, the tire 34 and/or the hub 32 may be manufactured via centrifugal casting, a.k.a. spin casting, which involves pouring one or more materials of the wheel 20ᵢ into a mold that rotates about an axis. The material(s) is(are) distributed within the mold via a centrifugal force generated by the mold's rotation. In some cases, vertical spin casting, in which the mold's axis of rotation is generally vertical, may be used. In other cases, horizontal spin casting, in which the mold's axis of rotation is generally horizontal, may be used. The wheel 20ᵢ may be manufactured using any other suitable manufacturing processes in other embodiments.

The NPT wheel 20ᵢ may be lightweight. That is, a mass M_{W} of the wheel 20ᵢ may be relatively small. For example, in some embodiments, a ratio M_{normalized} of the mass M_{W} of the wheel 20ᵢ over the outer diameter D_{W} of the wheel 20ᵢ normalized by the width W_{W} of the wheel 20ᵢ,

$${M}_{normalized} = \frac{( \frac{{M}_{w}}{{D}_{w}} )}{{W}_{w}}$$

may be no more than 0.0005 kg/mm², in some cases no more than 0.0004 kg/mm², in some cases no more than 0.0003 kg/mm², in some cases no more than 0.0002 kg/mm², in some cases no more than 0.00015 kg/mm², in some cases no more than 0.00013 kg/mm², in some cases no more than 0.00011 kg/mm², and in some cases even less (e.g., no more than 0.0001).

For instance, in some embodiments, the outer diameter of the wheel 20ᵢ may be 690 mm (27″), the width of the wheel 20ᵢ may be 230 mm (9″), and the mass M_{W} of the wheel 20ᵢ may be less than 25 kg, in some cases no more than 22 kg, in some cases no more than 20 kg, in some cases no more than 18 kg, in some cases no more than 16 kg, and in some cases even less.

The wheel 20ᵢ, including the tire 34 and the hub 32, may have various features to enhance its use and performance and/or use and performance of the ATV 10, including, for example, radial compliance characteristics to improve its shock-absorbing capability, lateral stiffness characteristics to improve the lateral stability of the ATV 10, and/or other features. This may be achieved in various ways in various embodiments, examples of which will now be discussed.

### 1. Enhanced Radial Compliance for Shock Absorption

In some embodiments, a radial compliance C_{z} of the wheel 20ᵢ may be significant. That is, a radial stiffness K_{z} of the wheel 20ᵢ may be relatively low for shock absorption (e.g., ride quality). The radial stiffness K_{z} of the wheel 20ᵢ is a rigidity of the wheel 20ᵢ in the radial direction of the wheel 20ᵢ, i.e., a resistance of the wheel 20ᵢ to deformation in the radial direction of the wheel 20ᵢ when loaded. The radial compliance C_{z} of the wheel 20ᵢ is the inverse of the radial stiffness K_{z} of the wheel 20ᵢ (i.e., C_{z}=1/K_{z}).

For example, in some embodiments, a ratio K_{z} normalized of the radial stiffness K_{z} of the wheel 20ᵢ over the outer diameter D_{W} of the wheel 20ᵢ normalized by the width W_{W} of the wheel 20ᵢ

$${K}_{Z normalized} = \frac{\frac{{K}_{z}}{{D}_{W}}}{{W}_{W}}$$

may be between 0.0001 kgf/mm³ and 0.0002 kgf/mm³, where the radial stiffness K_{z} of the wheel 20ᵢ is taken at a design load F_{DESIGN} of the wheel 20ᵢ, i.e., a normal load expected to be encountered by the wheel 20ᵢ in use such that only the tire 34 deflects by a normal deflection. A value of the K_{z normalized} below this range may result in a tire that has excessive deflection at the design load and therefore suffers in impact absorption, while a value of the K_{z normalized} above this range may result in a tire suffering in normal ride comfort, as its radial stiffness is too high. Herein, a force or load may be expressed in units of kilogram-force (kgf), but this can be converted into other units of force (e.g., Newtons).

The radial stiffness K_{z} of the wheel 20ᵢ may be evaluated in any suitable way in various embodiments.

For example, in some embodiments, the radial stiffness K_{z} of the wheel 20ᵢ may be gauged using a standard SAE J2704.

As another example, in some embodiments, the radial stiffness K_{z} of the wheel 20ᵢ may be gauged by standing the wheel 20ᵢ upright on a flat hard surface and applying a downward vertical load F_{z} on the wheel 20ᵢ at the axis of rotation 35 of the wheel 20ᵢ (e.g., via the hub 32). The downward vertical load F_{z} causes the wheel 20ᵢ to elastically deform from its original configuration (shown in dotted lines) to a biased configuration (show in full lines) by a deflection D_{z}. The deflection D_{z} is equal to a difference between a height of the wheel 20ᵢ in its original configuration and the height of the wheel 20ᵢ in its biased configuration. The radial stiffness K_{z} of the wheel 20ᵢ is calculated as the downward vertical load F_{Z} over the measured deflection D_{Z}.

For instance, in some embodiments, the radial stiffness K_{z} of the wheel 20ᵢ may be no more than 15 kgf/mm, in some cases no more than 11 kgf/mm, in some cases no more than 8 kgf/mm, and in some cases even less.

The radial compliance C_{z} of the wheel 20ᵢ is provided at least by a radial compliance C_{zt} of the non-pneumatic tire 34. For instance, in this embodiment, the spokes 42₁-42_{T} can deflect significantly in the radial direction of the wheel 20ᵢ under the loading on the wheel 20ᵢ. This may allow the wheel 20ᵢ to have a “pneumatic-like” zone of operation, which is characterized by relatively little strain in the tire 34 and relatively lower radial rigidity. In the pneumatic-like zone, the load from the contact patch to the hub 32 occurs primarily through tension in the spoked support 41 comprising the spokes 42₁-42_{T}.

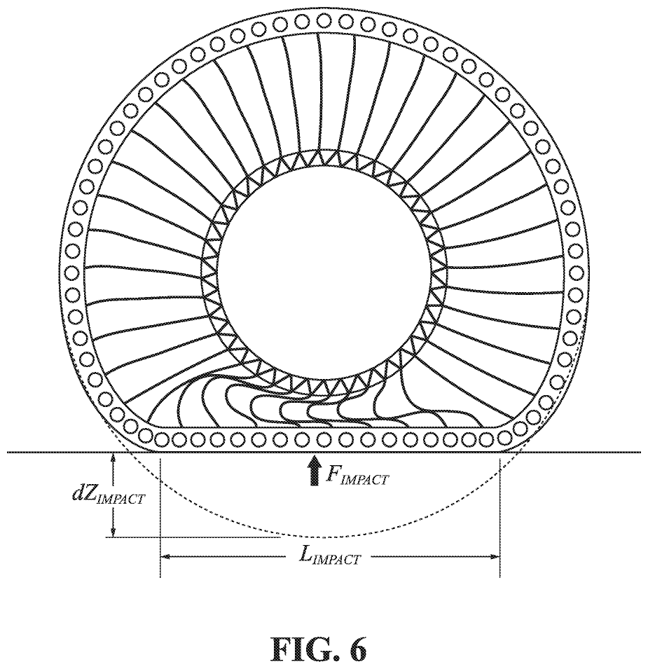

For example, in some embodiments, a volume fraction V_{fs} of the spoked support 41 comprising the spokes 42₁-42_{T} may be minimized. The volume fraction V_{fs} of the spoked support 41 refers to a ratio of a volume occupied by material of the spoked support 41 (i.e., a collective volume of the spokes 42₁-42_{T}) over a volume bounded by the annular beam 36 and the hub 32. A high value of the volume fraction V_{fs} increases the amount of material between the outer diameter D_{OT} and the inner diameter D_{IT} of the tire 34, whereas a low value of the volume fraction V_{fs} decreases the amount of material between the outer diameter D_{OT} and the inner diameter D_{IT} of the tire 34. At very high deflections, as shown in FIGS. 6, 7, 10, and 13, the spokes 42₁-42_{T} begin to self-contact. This, then, enables load transfer from the ground to the hub 32 via compression. Therefore, when the amount of material in the spoked support 41 is minimized, the pneumatic-like zone of operation of the wheel 20ᵢ is maximized. Thus, while this may be counterintuitive, minimizing material in the spoked support 41 may be beneficial to robustness of the wheel 20ᵢ in off-road use. Minimizing impact loading may be accomplished by maximizing the pneumatic-like zone, and this may be aided by minimizing the volume fraction V_{fs} of the spoked support 41.

For instance, in some embodiments, the volume fraction V_{fs} of the spoked support 41 may be no more than 15%, in some cases no more than 12%, in some cases no more than 10%, in some cases no more than 8%, in some cases no more than 6%, and in some cases even less. For example, in some embodiments, the volume fraction V_{fs} of the spoked support 41 may be between 6% and 9%.

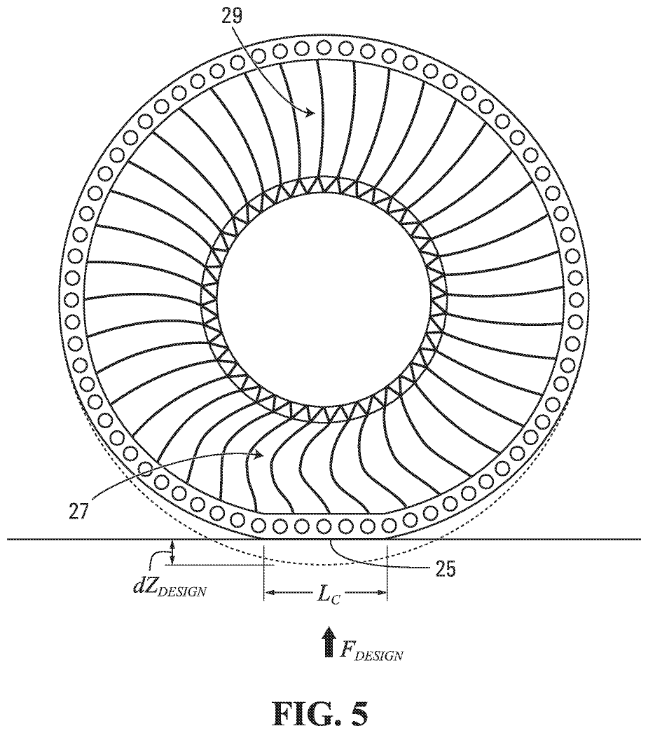

FIG. 4 shows a finite element model in the XZ plane of a representation of an embodiment of the wheel 20ᵢ according to the invention. FIG. 5 shows a normal operating condition. With the hub 32 fixed in the XZ plane, when loaded to the design load F_{DESIGN}, the wheel 20ᵢ develops the contact patch 25, whose length L_{C} corresponds to a design contact patch length L_{DESIGN}, and a radial deflection d_{Z-DESIGN}. These design quantities represent a force, contact patch length, and deflection seen in ordinary vehicle operation. As shown, d_{Z-DESIGN} is a small percentage of the diameter D_{W} of the wheel 20ᵢ.

The ATV 10 may often encounter obstacles and absorb impacts. Obstacles can be large rocks or tree stumps and the like. Impacts can also come from traversing jumps, or other maneuvers in which the ATV 10 leaves the ground, causing the suspension 18 and the wheels 20₁-20₄ to be subjected to impact forces.

FIG. 6 shows the wheel 20ᵢ responding to an impact. The impact force, F_{IMPACT}, causes deflection d_{Z-IMPACT} and results in the length L_{C} of the contact patch 25 to become an impact contact path length L_{IMPACT}. Due to the design of the NPT, d_{Z-IMPACT} can be a significant fraction of the diameter D_{W} of the wheel 20ᵢ. This may be very beneficial to off-road vehicle performance. The tire 34 represents un-sprung mass; as such, the speed with which it can deform is much faster than the speed with which the suspension 18 can displace the wheel 20ᵢ, or the speed with which a center of gravity of the ATV 10 can change. Thus, the ability of the tire 34 to resiliently deform as shown in FIG. 6 is a critical improvement in off-road vehicle behavior.

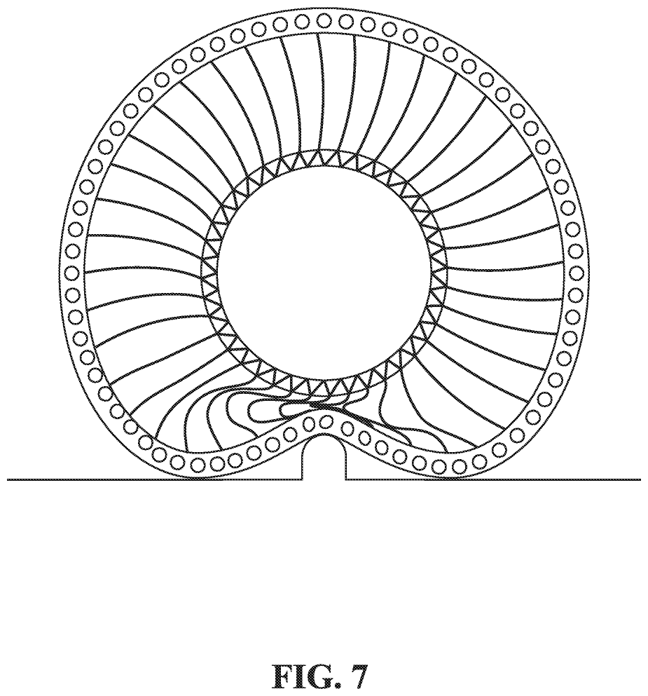

FIG. 7 shows the wheel 20ᵢ being rolled over an obstacle. The obstacle is essentially fully enveloped by the annular beam 36, similar to the performance of an inflated tire.

In some embodiments, the radial compliance C_{z} of the wheel 20ᵢ may not be provided solely by the radial compliance C_{zt} of the tire 34, but rather may be provided by the radial compliance C_{zt} of the tire 34 and a radial compliance C_{zh} of the hub 32. That is, in addition to the tire 34, the hub 32 may also be radially compliant.

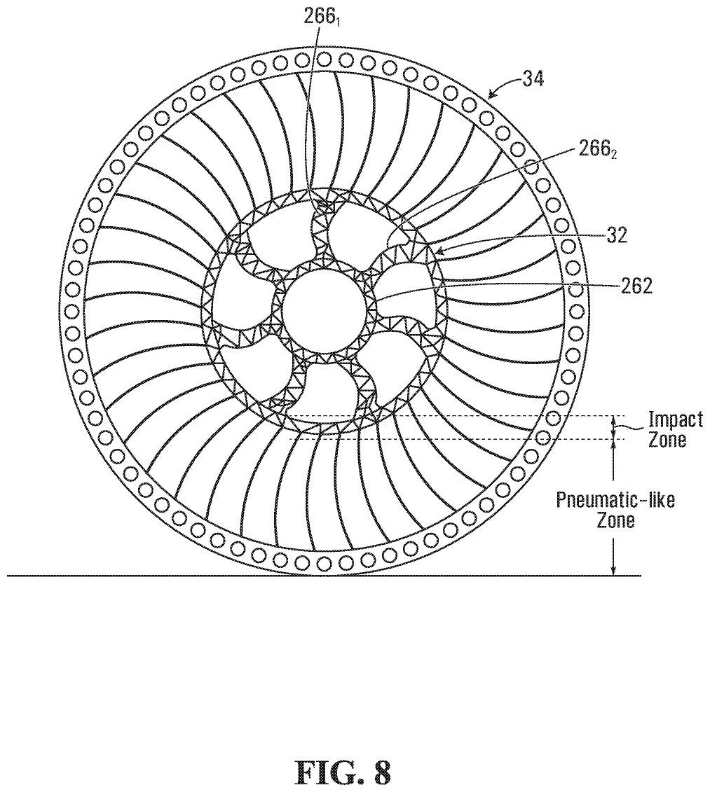

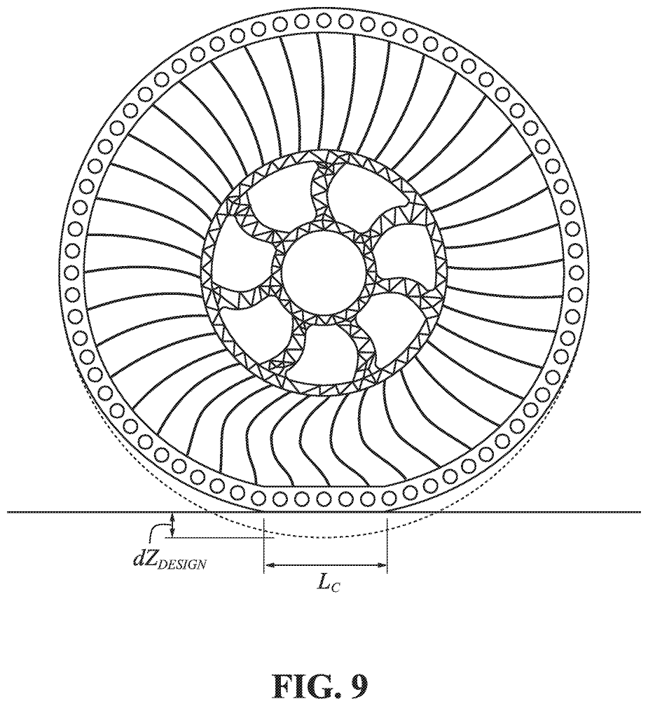

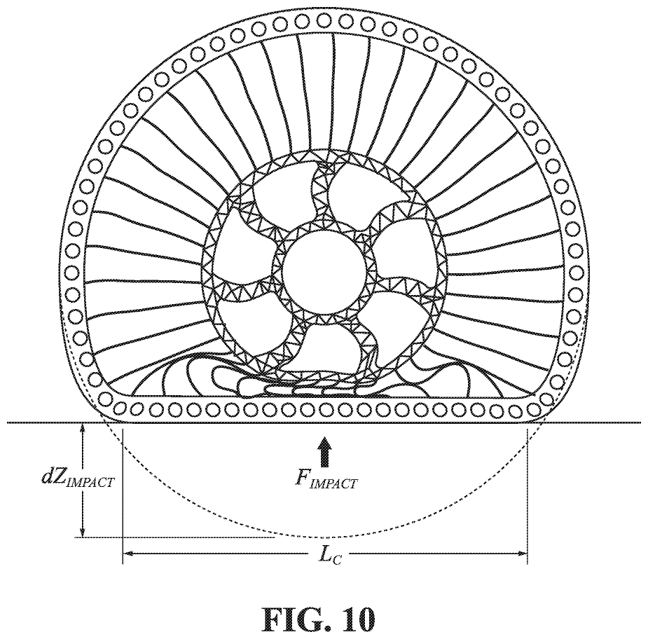

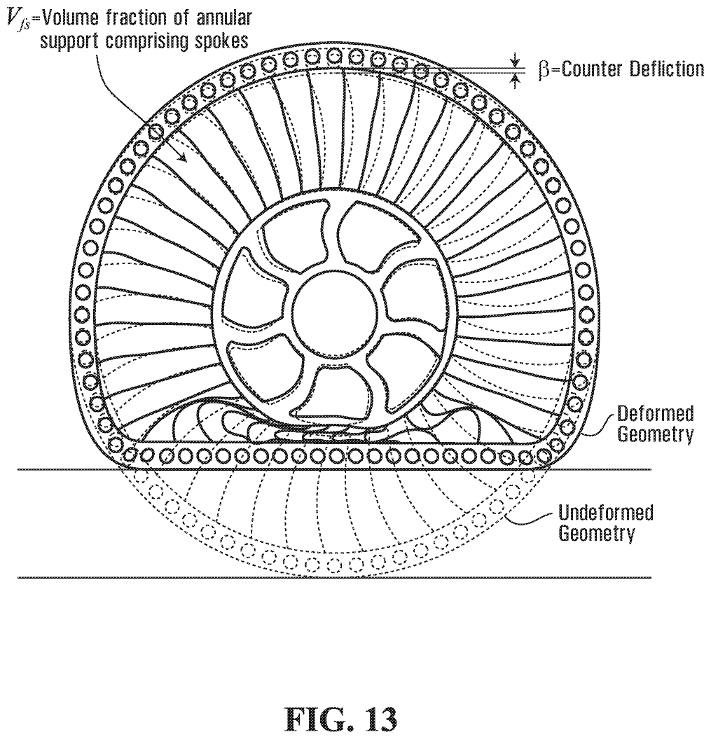

For instance, in some embodiments, as shown in FIGS. 8 to 13, the hub 32 may be resiliently deformable such that, in response to a given load on the wheel 20ᵢ, the hub 32 deforms elastically from a neutral configuration (shown in FIGS. 8 and 9) to a biased configuration (shown in FIGS. 10 and 13). The hub 32 being resiliently deformable may be useful in concert with the non-pneumatic tire 34. For a pneumatic tire, this may not necessarily be the case, as the pneumatic tire/wheel interface needs to remain a secure pressure vessel. With an NPT, this constraint is relaxed, and the hub 32 can be resiliently deformable.

The hub 32 which is resiliently deformable allows the wheel 20ᵢ to undergo two stages of deflection: the pneumatic-like zone of operation and an “impact zone” of operation. As indicated above, the pneumatic-like zone is characterized by relatively little strain in the tire 34 and relatively lower radial rigidity. In this embodiment, in the pneumatic-like zone, the load from the contact patch 25 to the hub 32 occurs primarily through tension in the spoked support 41 comprising the spokes 42₁-42_{T}. The impact zone is characterized by higher stresses and higher radial stiffness. In this impact zone, additional load from the contact patch 25 to the hub 32 occurs through compression of the annular beam 36, the spoked support 41, and the hub 32.

FIG. 9 shows the wheel 20ᵢ with the resiliently deformable hub 32 in a normal design condition. In this case, the resiliently deformable hub 32 does not deform; rather, it acts essentially like a rigid hub (e.g., a metallic hub).

FIG. 10 shows the wheel 20ᵢ with the resiliently deformable hub 32 subjected to an impact load F_{IMPACT} and a deflection d_{Z-IMPACT}. Now, there is significant additional compliance and deformation, thanks to the resiliently deformable hub 32. Thus, even very large deflections, in which d_{Z-IMPACT} is a larger percentage of the diameter D_{W} of the wheel 20ᵢ, are possible.

The hub 32 may be designed in any suitable way to be radially compliant. For instance, in some embodiments, the hub 32 may be made integrally with the tire 34 and comprise a central member 262 and a plurality of arms 266₁-266_{A} projecting radially outward from the central member 262. Each arm 266₁ is continuous with the tire 34 such that the tire material 45 is continuous with the hub material 72. That is, the hub material 72 may be elastomeric and the same as the tire material 45.

In this embodiment, unlike the arms 66₁-66_{A} of the hub 32 described above, the arms 266₁-266_{A} of the hub 32 do not project rectilinearly to the tire 34. Rather, each arm 266₁ is curved such that it deviates from a rectilinear path along the radial direction of the wheel 20ᵢ. The curved shape of the arms 266₁-266_{A} may allow the arms 266₁-266_{A} to deform elastically in response to a downward vertical load applied on the wheel 20ᵢ. In particular, the arms 266₁-266_{A} of the hub 232 behave in a similar manner to the spokes 42₁-42_{T} of the tire 34. Notably, the arms 266₁-266_{A} of the hub 232 may be placed in tension or in compression depending on their position. For instance, the arms 266₁-266_{A} that are in a lower region of the hub 32 adjacent the contact patch 25 of the wheel 20ᵢ are placed in compression and bend under the applied load while the arms 266₁-266_{A} that are in an upper region of the hub 32 (i.e., above the axis of rotation 35 of the wheel 20ᵢ) are placed in tension to support the applied load.

For example, in some embodiments, the pneumatic-like zone deflection may be at least 25%, in some cases at least 30%, and in some cases at least 35% of the diameter D_{W} of the wheel 20ᵢ and/or the impact zone deflection may be at least 5%, in some cases 8%, and in some cases at least 10% of the diameter D_{W} of the wheel 20ᵢ.

For example, in some embodiments, for the wheel 20ᵢ of FIG. 10 in which the diameter D_{W} is 300 mm. a pneumatic zone deflection of 115 mm and an impact zone deflection of 20 mm may yield excellent on-vehicle performance for an NPT of this size.

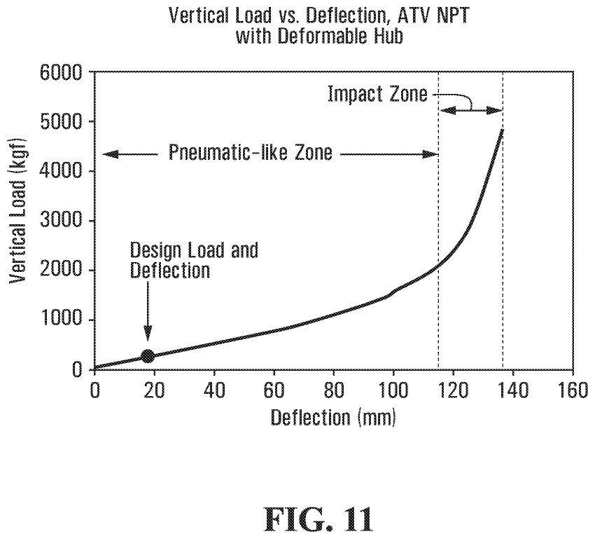

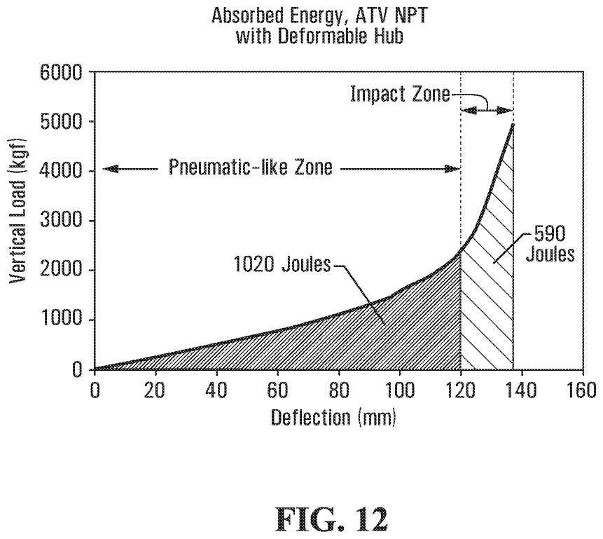

FIG. 11 shows an example of a load vs. deflection plot for the FEA model shown in FIGS. 8, 9, and 10. The pneumatic-like zone and the impact zone are shown, clearly differentiated by the change in radial stiffness. In the pneumatic-like zone, the radial stiffness is about 12 kgf/mm, whereas in the impact zone, the radial stiffness increases to about 200 kgf/mm. FIG. 12 shows the large amount of absorbed energy developed within each zone.

In FIG. 11, the design load for the wheel 20ᵢ of 230 kgf is achieved at the low deflection of around 18 mm. Therefore, the design deflection is a small fraction of around 16% of the pneumatic-like zone. This may be advantageous to vehicle comfort and stability, as the amount of tire deflection available for use during impacts is maximized. In fact, this dual approach—maximizing the pneumatic-like zone distance and minimizing the design deflection—may give excellent performance.

In this embodiment, this may be partially accomplished thanks to two factors: (1) a high counter deflection stiffness and (2) a low volume fraction V_{fs} of the spoked support 41 comprising the spokes 42₁-42_{T}.

FIG. 13 shows a superposition of the undeformed and deformed tire geometries for the loading condition of FIG. 10. When the central section of the resiliently deformable hub 32 is fixed, as shown, and the tire is loaded, the whole wheel 20ᵢ deforms. Load is passed from the contact patch 25 to the hub 32 via tension in the spokes 42₁-42_{T}, as the annular beam 36 is deflected upwards. As shown, the spokes 42₁-42_{T} become taunt when the tire is loaded, and the annular beam 36 is translated up by a small amount β, known as the “counter deflection”, in the region opposite the contact patch 25. This counter deflection is parasitic. A high counter deflection reduces the contact patch length for a given load, and reduces the effective deflection of the annular beam 36 in obstacle envelopment. For instance, in some embodiments, a maximum counter deflection for the wheel 20ᵢ may be about 6 mm to 11 mm, which is about 6% to 11% of the pneumatic-like zone of operation of the NPT.

### 2. Enhanced Lateral Stiffness for Lateral Stability

In some embodiments, the wheel 20ᵢ may improve the lateral stability of the ATV 10, such as when the ATV 10 performs a maneuver (e.g., a lane change) or during other transient situations in which the wheel 20ᵢ is subject to lateral loading.

To that end, a lateral stiffness K_{y} of the wheel 20ᵢ may be relatively high. The lateral stiffness of the wheel 20ᵢ is a rigidity of the wheel 20ᵢ in the widthwise direction of the wheel 20ᵢ, i.e., a resistance of the wheel 20ᵢ to deformation in the widthwise direction of the wheel 20ᵢ when loaded in the widthwise direction of the wheel 20ᵢ. A cornering stiffness K_{δ} of the wheel 20ᵢ may also be relatively high.

For instance, in some embodiments, the wheel 20ᵢ may yield better lateral stability than a pneumatic tire without sacrificing ride comfort. For instance, in some cases, this may be because the lateral stiffness of the wheel 20ᵢ and the cornering stiffness of the wheel 20ᵢ can be decoupled from the radial stiffness and total radial energy absorption of the wheel 20ᵢ.

Poor lateral stiffness and/or cornering stiffness could otherwise result in vehicle terminal oversteer, in which the rear of the ATV 10 could lose traction in a turn and begin to yaw uncontrollably. Then, if the center of gravity of the ATV 10 is high and/or if other causes are present, the ATV 10 could experience a roll-over event. Therefore, having the lateral stiffness and the cornering stiffness that are high may be useful.

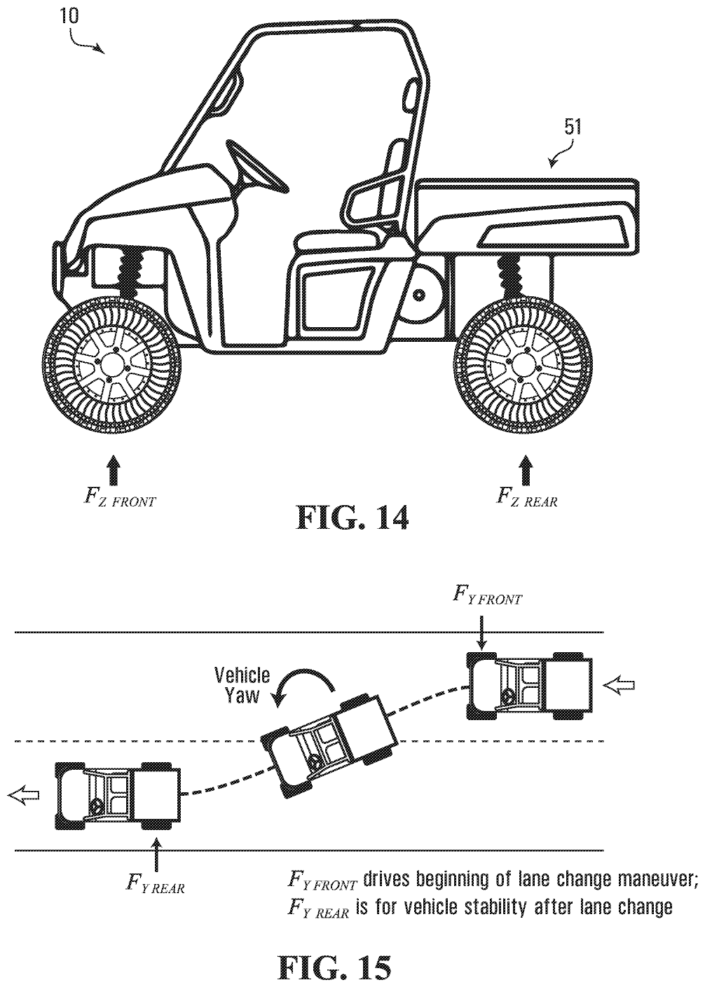

For example, FIG. 14 shows a variant of the ATV 10 which is a UTV that has a cargo area 51 in the rear of the ATV 10. For instance, in this example, the cargo area 51 can carry up to 450 kg, at vehicle speeds of up to 80 kph. Thus, there is a large difference in the per tire load at the rear axle, F_{Z REAR}, when the cargo area 51 is empty and when it is full. F_{Z REAR} can vary from 230 kg (unloaded) to 450 kg (loaded). This may create challenges for vehicle stability in a lane change maneuver.

An aerial view of a lane change maneuver is shown in FIG. 15. At the beginning of the lane change, the ATV 10 must develop a large lateral force at the front axle. After the ATV 10 crosses into the adjoining lane, the driver reverses steering angle to center the vehicle in the lane. The vehicle yaw rapidly changes directions. Then, quite critically, the rear axle tires must develop sufficient cornering force to “catch” the vehicle after the lane change, and the rear axle tires must have sufficient lateral stiffness to support the lateral force.

With the ATV 10 in the unloaded state, such transient stability may be challenging. With no cargo, the initial vehicle yaw rate can be quite high; yet, the rear axle tires are lightly loaded. This may make it difficult for the rear axle tires to develop sufficient force to decelerate the vehicle yaw and stabilize the vehicle after the lane change is executed.

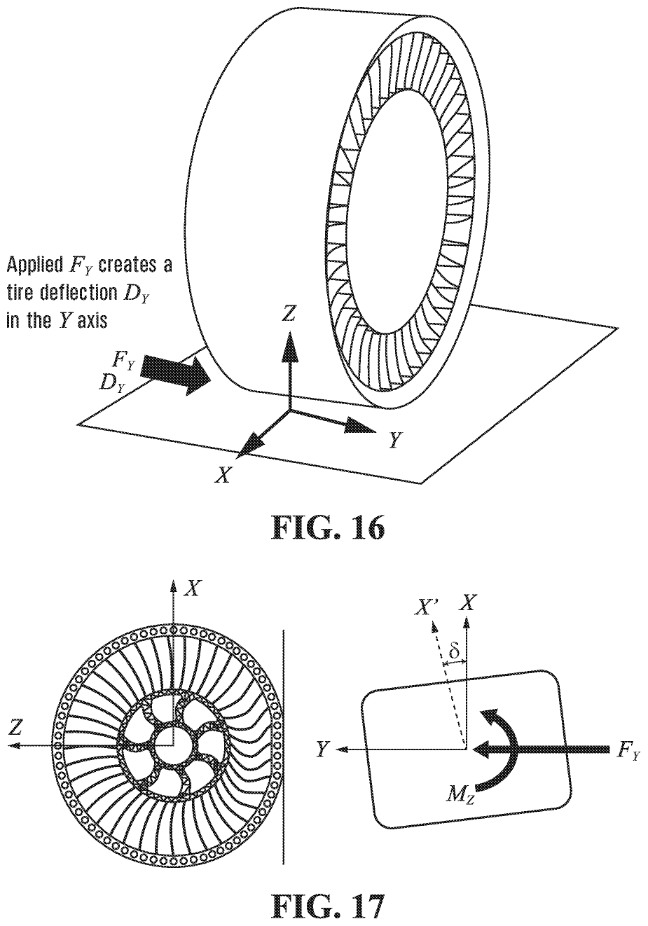

FIG. 16 illustrates the lateral stiffness K_{y} of the wheel 20ᵢ. Here, the wheel 20ᵢ is loaded to a design load in the Z direction against a flat surface. Then, the ground is deflected in the Y direction, creating a lateral force F_{y} on the wheel 20ᵢ which induces a deflection D_{Y} of the wheel 20ᵢ in the lateral direction of the wheel 20ᵢ. The lateral stiffness K_{Y} of the wheel 20ᵢ is F_{Y}/D_{Y}, in kgf/mm.

FIG. 17 illustrates the cornering stiffness K_{δ} of the wheel 20ᵢ. The rectangular area is the contact patch 25 of the wheel 20ᵢ as it travels in the X direction, with a slip angle δ. As it does so, a reaction moment M_{Z} is created. This is the self-aligning torque. A reaction force F_{Y} is also created. This force is a cornering force. The cornering stiffness K_{δ} of the wheel 20ᵢ is F_{Y}/δ, in kgf/degree.

Therefore, in some embodiments, in contrast to the radial stiffness K_{z} of the wheel 20ᵢ which may be relatively low, the lateral stiffness K_{y} of the wheel 20ᵢ may be relatively high, notably due to the construction of the non-pneumatic tire 34. The lateral stiffness K_{y} of the wheel 20ᵢ may thus be considerably greater than the radial stiffness K_{z} of the wheel 20ᵢ in some embodiments.

For example, in some embodiments, a ratio K_{y}/K_{z} of the lateral stiffness K_{y} of the wheel 20ᵢ over the radial stiffness K_{z} of the wheel 20ᵢ measured at the rear axle load of the ATV 10 with no cargo may be at least 1.6, in some cases at least 1.8, in some cases at least 2, and in some cases even more. The ratio K_{y}/K_{z} may have any other suitable value in other embodiments.

The lateral stiffness K_{y} of the wheel 20ᵢ may be evaluated in any suitable way in various embodiments.

For instance, in one example, the lateral stiffness K_{y} of the wheel 20ᵢ may be gauged using a standard SAE J2718 test.

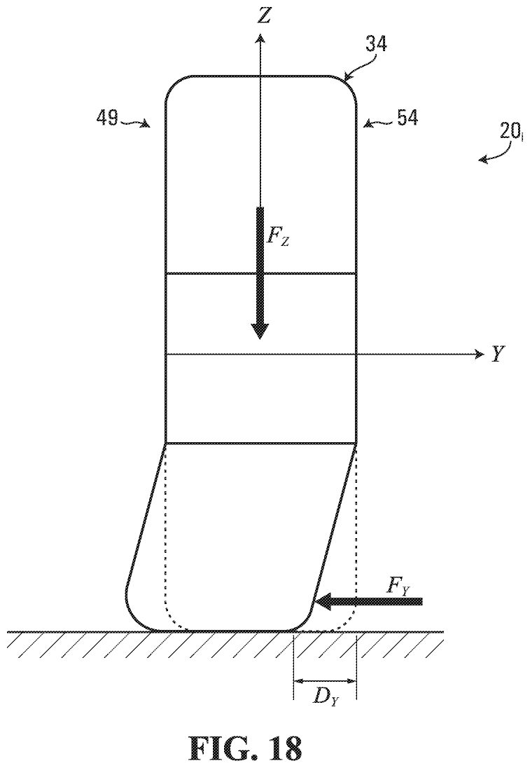

In another example, as shown in FIG. 18, the lateral stiffness K_{y} of the wheel 20ᵢ may be gauged by applying a lateral load F_{y} on a given one of the outboard lateral side 49 and the inboard lateral side 54 of the tire 34. The lateral load F_{y} causes the wheel 20ᵢ, notably the tire 34, to elastically deform from its original configuration (shown in dotted lines) to a biased configuration (shown in full lines) by a deflection D_{y} in the lateral direction of the wheel 20ᵢ. The lateral stiffness of the wheel 20ᵢ is calculated as the lateral load F_{y} over the measured lateral deflection D_{y} of the wheel 20ᵢ.

For example, in some embodiments, the lateral stiffness K_{y} of the wheel 20ᵢ may be at least 15 kgf/mm, in some cases at least 20 kgf/mm, in some cases at least 30 kgf/mm, and in some cases even more.

The cornering stiffness K_{δ} of the wheel 20ᵢ may also be relatively high, notably due to the construction of the non-pneumatic tire 34.

For instance, in some embodiments, a ratio K_{δ}/F_{z} of the cornering stiffness K_{δ} of the wheel 20ᵢ at one degree over the rear axle load F_{z} of the ATV 10 with no cargo may be at least 0.2, in some cases at least 0.3, in some cases at least 0.4 and in some cases even more. The ratio K_{δ}/F_{z} may have any other suitable value in other embodiments.

The cornering stiffness K_{δ} of the wheel 20ᵢ may be evaluated in any suitable way in various embodiments.

For instance, in one example, the cornering stiffness K_{δ} of the wheel 20ᵢ may be gauged by measurement on an industry standard Flat-Trac machine, such as that used by Smithers Rapra Corporation.

For example, in some embodiments, the cornering stiffness K_{δ} of the wheel 20ᵢ, when measured at a design load, may be at least 40 kgf/deg, in some cases at least 60 kgf/deg, in some cases at least 80 kgf/deg, and in some cases even more.

The lateral stiffness K_{y} and the cornering stiffness K_{δ} of the wheel 20ᵢ may be achieved in any suitable way.

For example, in some embodiments, a width Wₛ of the spoked support 41 comprising the spokes 42₁-42_{T} may be significant in relation to the width W_{T} of the tire 34. For instance, in some embodiments, a ratio of the width Wₛ of the spoked support 41 over the width W_{T} of the tire 34 may be at least 0.7, in some cases at least 0.8, in some cases at least 0.9, and in some cases even more. For example, in some cases, the spoked support 41 may extend substantially completely across the annular beam 36 in the axial direction of the wheel 20ᵢ.

Other design attributes may also increase the lateral stiffness K_{y} and the cornering stiffness K_{δ} of the wheel 20ᵢ. For example, in some embodiments, a stiffness of the annular beam 36 in the circumferential direction may increase the lateral stiffness K_{y} of the wheel 20ᵢ. Increasing a stiffness of the spoked support 41, via an increase in material modulus of elasticity, may increase the lateral stiffness K_{y} of the wheel 20ᵢ. Adding reinforcement materials, such as short or long fiber reinforcements, may also increase the lateral stiffness K_{y} of the wheel 20ᵢ.

The enhanced radial compliance C_{z} (or, inversely, radial stiffness K_{z}) and the enhanced lateral stiffness K_{y} of the wheel 20ᵢ as discussed above in sections 1 and 2 may be particularly useful with the wheel 20ᵢ being lightweight, such as where the mass Mw of the wheel 20ᵢ, including a mass MT of the non-pneumatic tire 34, may be relatively low as discussed above.

Also, the enhanced radial compliance C_{z} (or, inversely, radial stiffness K_{z}) and the enhanced lateral stiffness K_{y} of the wheel 20ᵢ as discussed above in sections 1 and 2 may be particularly useful as the ATV 10 travels fast, such as at a speed of at least 50 km/h, in some cases at least 70 km/h, in some cases at least 90 km/h, and in some cases even faster.

### 3. Modular Wheel

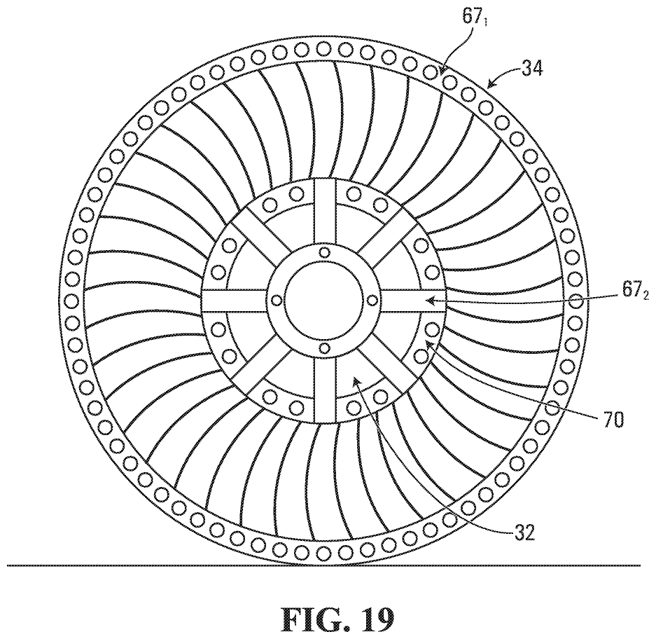

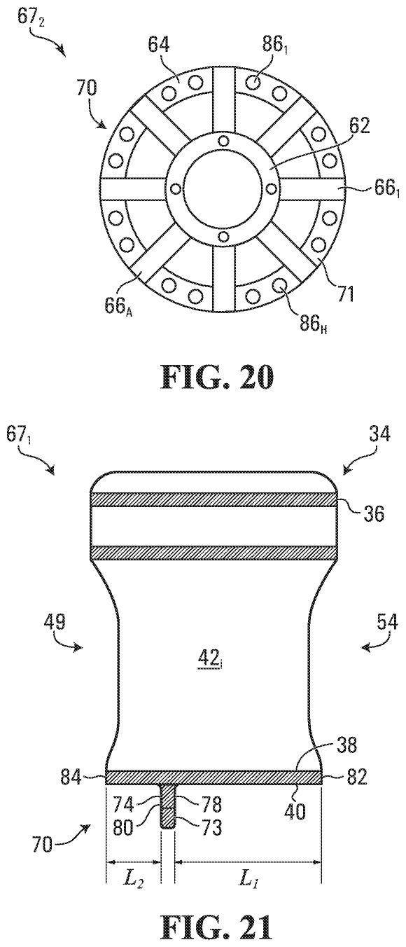

In some embodiments, as shown in FIGS. 19 to 21, the wheel 20ᵢ may be modular in that it may comprise a plurality of modules 67₁-67_{C} that are assembled and connected to one another. For instance, in some embodiments, respective ones of the modules 67₁-67_{C} may be detachably connected to one another (i.e., separate components that can be selectively attached to and detached from one another). One or more of the modules 67₁-67_{C} may be selected from a set of different modules and/or replaceable by a different module. This may be beneficial to allow the wheel 20ᵢ to be adapted to a variety of different ATVs.

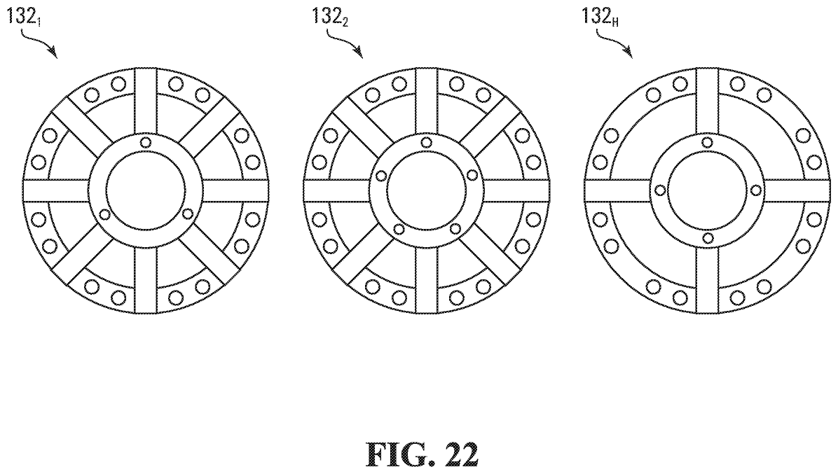

In this embodiment, a module 671 comprises the non-pneumatic tire 34 and a module 672 comprises the hub 32. More particularly, in this embodiment, the hub 32 may be selected from a set of different hubs and/or replaceable by a different hub. Examples of different hubs 132₁-132_{H} having different characteristics (e.g., different bolt patterns) are illustrated in FIG. 22. This may allow the wheel 20ᵢ to accommodate different ATVs which may require different configurations of the hub 32 (e.g., different bolt patterns).

More particularly, in this embodiment, the tire 34 and the hub 32 are detachably connected to one another (i.e., they are selectively attachable to and detachable from one another). The wheel 20ᵢ comprises an attachment mechanism 70 for connecting the tire 34 and the hub 32. The attachment mechanism 70 comprises a connector 71 that is part of the hub 32 and a connector 73 that is part of the tire 34 and connectable to the connector 71 of the hub 32. More particularly, in this embodiment, the connector 71 comprises the outer member 64 of the hub 32 and the connector 73 comprises a flange 74 projecting inwardly from an inner annular member 38 of the tire 34 from which the spokes 42₁-42_{T} extend radially outwardly.

The flange 74 of the tire 34 comprises an inboard surface 78 facing the inboard lateral side 54 of the tire 34 and an outboard surface 80 facing the outboard lateral side 49 of the tire 34. The flange 74 is positioned such that a distance L₁ measured between the inboard surface 78 and an inboard lateral end 82 of the inner annular member 38 adjacent the inboard lateral side 54 of the tire 34 is greater than half the distance L₂ which is the total lateral distance of the inboard surface 40 from outboard lateral end 84 to the inboard lateral end 82. For instance, a ratio L₁/L₂ may be at least 0.5, in some cases at least 0.7, in some cases may approach 1. This positioning of the flange 74 may allow the hub 32 to be spaced from the axle 17 and/or brake mechanism of the ATV 10 that is housed within a space defined by an inner peripheral surface 40 of the inner annular member 38 when the wheel 20ᵢ is mounted to the ATV 10 such that the hub 32 does not contact the axle 17 and/or brake mechanism of the ATV 10.

In this embodiment, the outer member 64 of the hub 32 comprises a plurality of holes 86₁-86_{H} that traverse the outer member 64 and the flange 74 of the tire 34 comprises a plurality of holes 96₁-96_{H} that traverse the flange 74. The holes 86₁-86_{H}, 96₁-96_{H} are configured such that when the hub 32 is disposed on the tire 34, each hole 86ᵢ can be aligned with a corresponding hole 96ᵢ.

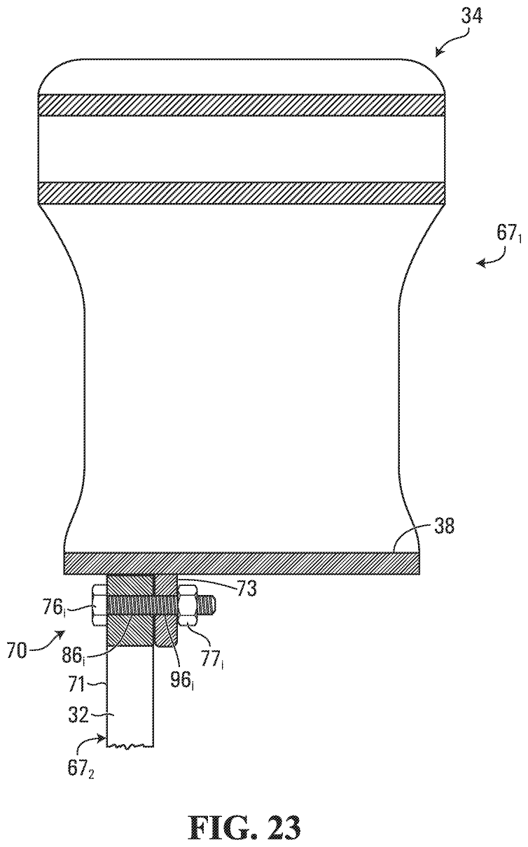

In order to connect the tire 34 to the hub 32, the hub 32 is disposed on the flange 74 to bring the outer member 64 of the hub 32 into contact with the outboard lateral surface 80 of the flange 74 of the tire 34. The holes 86₁-86_{H} of the hub 32 are then aligned with the holes 96₁-96_{H} of the flange 74. In this embodiment, the attachment mechanism 70 further comprises a plurality of fastening elements 76₁-76_{F} (e.g., bolts) to secure to the outer member 64 to the flange 74. As shown in FIG. 23, each fastening element 76ᵢ is inserted into a holes 86ᵢ of the outer member 64 of the hub 32 and into a hole 96ᵢ of the flange 74 of the tire 34 and is secured accordingly via a corresponding fastening element 77ᵢ (e.g., a nut). In some embodiments, a clamping plate may be provided between a head of the fastening element 76ᵢ and the outer member 64 to distribute the force applied by the fastening elements 76ᵢ on the outer member 64 and the flange 74.

The attachment mechanism 70 may be implemented in any other suitable way in other embodiments (e.g., different types of fasteners, a quick-connect system, etc.).

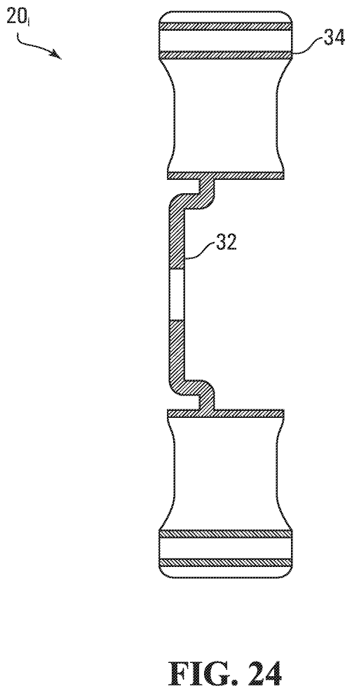

Instead of being distinct modules, as shown in FIG. 24 and as discussed and shown in previous examples of implementation considered above, in some embodiments, the hub 32 and the tire 34 of the wheel 20ᵢ may be a single-piece construction (i.e., integrally formed with one another as one piece). Thus, in some embodiments, the wheel 20ᵢ may consist of a single-piece construction. In such embodiments, the tire material 45 and the hub material 72 may be the same material or may be different materials (e.g., by introducing different materials at different times during spin casting).

### 4. Different Energy Absorption Properties

In some embodiments, the wheel 20ᵢ may have different energy absorption properties than that imparted by the compliance of the tire 34 and/or the hub 32. For instance, while the radial compliance of the wheel 20ᵢ imparts the wheel 20ᵢ with spring-like energy absorption properties, in some embodiments, the wheel 20ᵢ may also include energy damping properties. That is, the wheel 20ᵢ may have damping properties that allow the wheel 20ᵢ to dissipate energy. For instance, in some embodiments, the wheel 20ᵢ may comprise a damping mechanism 90 for providing energy damping properties to the wheel 20ᵢ. The damping mechanism 90 of the wheel 20ᵢ may be implemented in various ways.

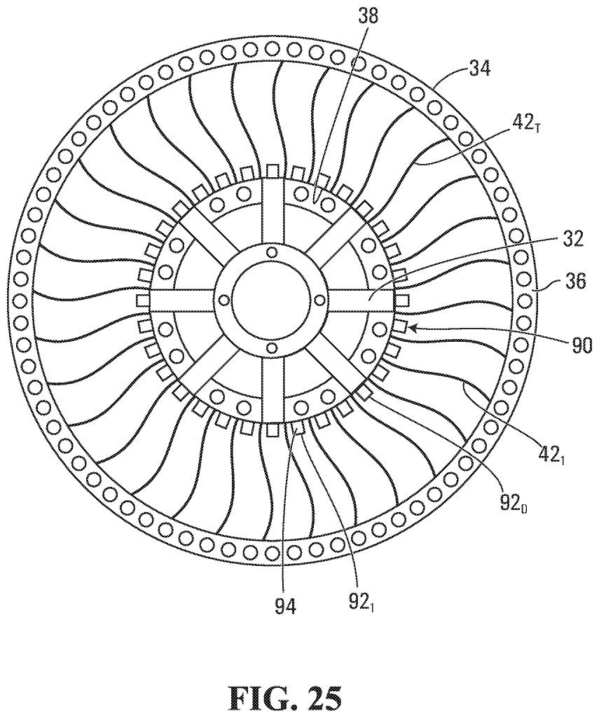

With additional reference to FIG. 25, in one example of implementation, the damping mechanism 90 is comprised by the tire 34 and comprises a plurality of damping elements 92₁-92_{D} that are disposed on the inner annular member 38 of the tire 34 and projecting radially outwardly therefrom. More particularly, the damping elements 92₁-92_{D} are positioned between adjacent ones of the spokes 42₁-42_{T}. The damping elements 92₁-92_{D} can be affixed to inner annular member 38 in any suitable way. For instance, in this example, the damping elements 92₁-92_{D} are fastened to the inner annular member 38 via fasteners (e.g., bolts, screws, etc.).

Each damping element 92ᵢ comprises a damping material 94 that dissipates energy when impacted. For example, in this embodiment, the damping material 94 is rubber. The damping material 94 of the damping element 92ᵢ may be any other suitable material in other embodiments.

In use, when the wheel 20ᵢ deforms radially in response to a load, the annular beam 36 at the contact patch 25 may contact one or more the damping elements 92₁-92_{D} or may cause certain spokes 42₁-42_{T} to contact one or more of the damping elements 92₁-92_{D}. This contact with the damping elements 92₁-92_{D} transfers the load that would otherwise be absorbed by the compliance of the tire 34 to the damping elements 92₁-92_{D}. Due to their damping properties, the damping elements 92₁-92_{D} dissipate the energy from such an impact.

The damping mechanism 90 may be configured in any other suitable way in other embodiments.

### 5. Reinforced Annular Beam

In some embodiments, the annular beam 36 may comprise one or more reinforcing layers running in the circumferential direction of the wheel 20ᵢ to reinforce the annular beam 36, such as one or more substantially inextensible reinforcing layers running in the circumferential direction of the wheel 20ᵢ (e.g., one or more layers of metal, composite (e.g., carbon fibers, other fibers), and/or another material that is substantially inextensible running in the circumferential direction of the wheel 20ᵢ). For instance, this may reinforce the annular beam 36 by protecting it against cracking and/or by better managing heat generated within it as it deforms in use.

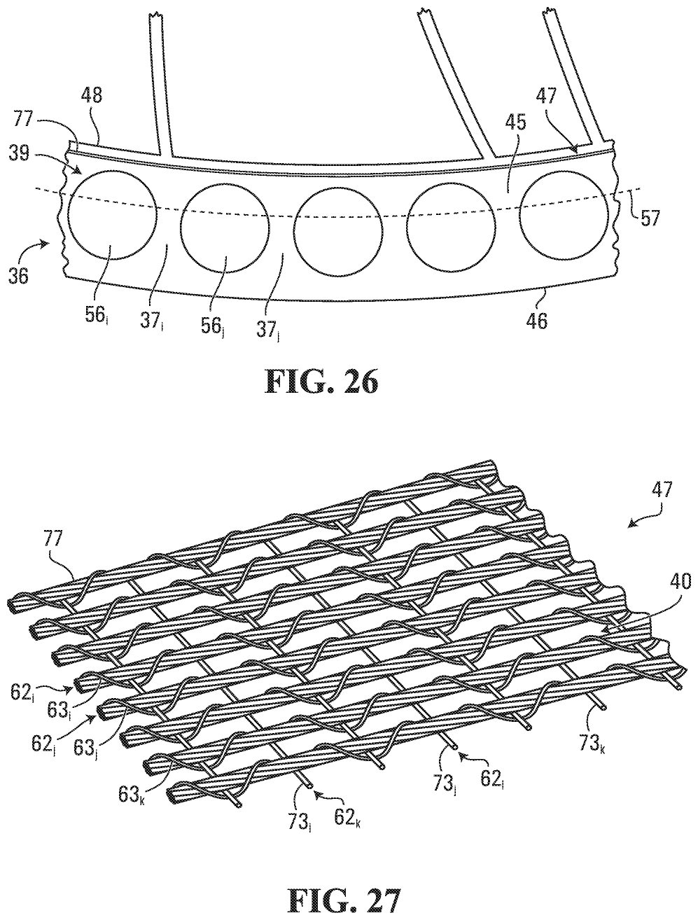

For example, in some embodiments, as shown in FIG. 26, the annular beam 36 may comprise a reinforcing layer 47 running in the circumferential direction of the wheel 20ᵢ

The reinforcing layer 47 is unnecessary for the annular beam 36 to deflect predominantly by shearing, i.e., unnecessary for the shear band 39 to deflect significantly more by shearing than by bending at the contact patch 25 of the wheel 20ᵢ. That is, the annular beam 36 would deflect predominantly by shearing even without the reinforcing layer 47. In other words, the annular beam 36 would deflect predominantly by shearing if it lacked the reinforcing layer 47 but was otherwise identical. Notably, in this embodiment, this is due to the openings 56₁-56_{N} and the interconnecting members 37₁-37_{P} of the shear band 39 that facilitate deflection predominantly by shearing.

The annular beam 36 has the reinforcing layer 47 but is free of any equivalent reinforcing layer running in the circumferential direction of the wheel 20ᵢ and spaced from the reinforcing layer 47 in the radial direction of the wheel 20ᵢ. That is, the annular beam 36 has no reinforcing layer that is equivalent, i.e., identical or similar in function and purpose, to the reinforcing layer 47 and spaced from the reinforcing layer 47 in the radial direction of the wheel 20ᵢ. The annular beam 36 therefore lacks any reinforcing layer that is comparably stiff to (e.g., within 10% of a stiffness of) the reinforcing layer 47 in the circumferential direction of the wheel 20ᵢ and spaced from the reinforcing layer 47 in the radial direction of the wheel 20ᵢ.

In this embodiment, the annular beam 36 has the reinforcing layer 47 but is free of any substantially inextensible reinforcing layer running in the circumferential direction of the wheel 20ᵢ and spaced from the reinforcing layer 47 in the radial direction of the wheel 20ᵢ. Thus, the reinforcing layer 47 is a sole reinforcing layer of the annular beam 36.

More particularly, in this embodiment, the annular beam 36 has the reinforcing layer 47 located on a given side of a neutral axis 57 of the annular beam 36 and is free of any substantially inextensible reinforcing layer running in the circumferential direction of the wheel 20ᵢ on an opposite side of the neutral axis 57 of the annular beam 36. That is, the reinforcing layer 47 is located between the neutral axis 57 of the annular beam 36 and a given one of the inner peripheral extent 48 and the outer peripheral extent 46 of the annular beam 36 in the radial direction of the wheel 20ᵢ, while the annular beam 36 is free of any substantially inextensible reinforcing layer running in the circumferential direction of the wheel 20ᵢ between the neutral axis 57 of the annular beam 36 and the other one of the inner peripheral extent 48 and the outer peripheral extent 46 of the annular beam 36 in the radial direction of the wheel 20ᵢ.

The neutral axis 57 of the annular beam 36 is an axis of a cross-section of the annular beam 36 where there is substantially no tensile or compressive stress in the circumferential direction of the wheel 20ᵢ when the annular beam 36 deflects at the contact patch 25 of the wheel 20ᵢ. In this example, the neutral axis 57 is offset from a midpoint of the annular beam 36 between the inner peripheral extent 48 and the outer peripheral extent 46 of the annular beam 36 in the radial direction of the wheel 20ᵢ. More particularly, in this example, the neutral axis 57 is closer to a given one of the inner peripheral extent 48 and the outer peripheral extent 46 of the annular beam 36 than to an opposite one of the inner peripheral extent 48 and the outer peripheral extent 46 of the annular beam 36 in the radial direction of the wheel 20ᵢ.

In this embodiment, the reinforcing layer 47 is disposed radially inwardly of the neutral axis 57 of the annular beam 36, and the annular beam 36 is free of any substantially inextensible reinforcing layer running in the circumferential direction of the wheel 20ᵢ radially outwardly of the neutral axis 57 of the annular beam 36.

In this example, the reinforcing layer 47 is disposed between the inner peripheral extent 48 of the annular beam 36 and the openings 56₁-56_{N} in the radial direction of the wheel 20ᵢ, while the annular beam 36 is free of any substantially inextensible reinforcing layer running in the circumferential direction of the wheel 20ᵢ between the outer peripheral extent 46 of the annular beam 36 and the openings 56₁-56_{N} in the radial direction of the wheel 20ᵢ.

The reinforcing layer 47 may be implemented in any suitable way in various embodiments.

For example, in some embodiments, as shown in FIG. 27, the reinforcing layer 47 may include a layer of elongate reinforcing elements 62₁-62_{E} that reinforce the annular beam 36 in one or more directions in which they are elongated, such as the circumferential direction of the wheel 20ᵢ and/or one or more directions transversal thereto.

For instance, in some embodiments, the elongate reinforcing elements 62₁-62_{E} of the reinforcing layer 47 may include reinforcing cables 63₁-63_{C} that are adjacent and generally parallel to one another. For instance, the reinforcing cables 63₁-63_{C} may extend in the circumferential direction of the wheel 20ᵢ to enhance strength in tension of the annular beam 36 along the circumferential direction of the wheel 20ᵢ. In some cases, a reinforcing cable may be a cord or wire rope including a plurality of strands or wires. In other cases, a reinforcing cable may be another type of cable and may be made of any material suitably flexible longitudinally (e.g., fibers or wires of metal, plastic or composite material).

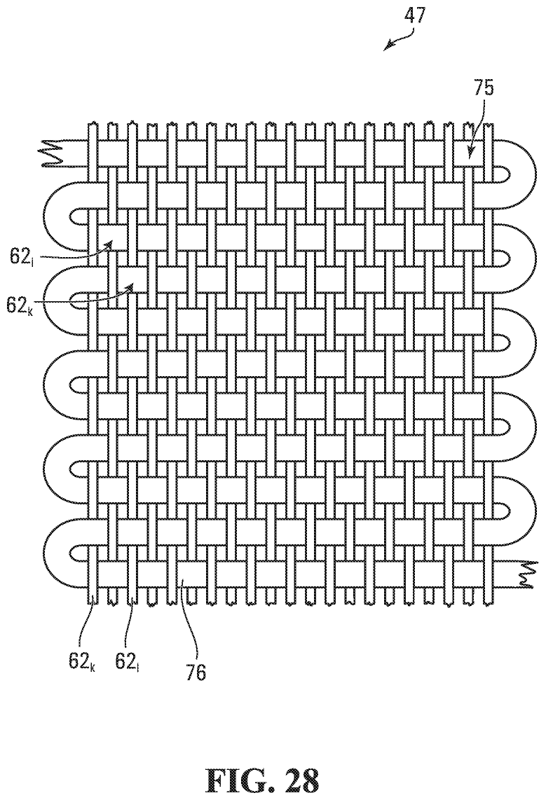

In some embodiments, the elongate reinforcing elements 62₁-62_{E} of the reinforcing layer 47 may include constitute a layer of reinforcing fabric 65. Reinforcing fabric comprises pliable material made usually by weaving, felting, knitting, interlacing, or otherwise crossing natural or synthetic elongated fabric elements, such as fibers, filaments, strands and/or others. For instance, as one example, in some embodiments such as that of FIG. 27, the elongate reinforcing elements 62₁-62_{E} of the reinforcing layer 47 that include the reinforcing cables 63₁-63_{C} may also include transversal fabric elements 73₁-73_{T} that extend transversally (e.g., perpendicularly) to and interconnect the reinforcing cables 63₁-63_{C}. Thus, in this example, the reinforcing layer 47, including its reinforcing cables 63₁-63_{C} and its transversal fabric elements 73₁-73_{T}, can be viewed as a reinforcing fabric or mesh (e.g., a “tire cord” fabric or mesh). As another example, in some embodiments, as shown in FIG. 28, the reinforcing fabric 47 may include textile 75 (e.g., woven or nonwoven textile).

In other examples of implementation, the reinforcing layer 47 may include a reinforcing sheet (e.g., a thin, continuous layer of metallic material, such as steel or aluminum that extends circumferentially).

The reinforcing layer 47 may be made of one or more suitable materials. A material 77 of the reinforcing layer 47 may be stiffer and stronger than the elastomeric material 45 of the annular beam 36 in which it is disposed. For instance, in some embodiments, the material 77 of the reinforcing layer 47 may be a metallic material (e.g., steel, aluminum, etc.). In other embodiments, the material 77 of the reinforcing layer 47 may be a stiff polymeric material, a composite material (e.g., a fiber-reinforced composite material), etc.

In this example of implementation, the reinforcing layer 47 comprises the reinforcing mesh or fabric that includes the reinforcing cables 63₁-63_{C} and the transversal fabric elements 73₁-73_{T} which are respectively 3 strands of steel wire of 0.28 mm diameter, wrapped together to form a cable, and high tenacity nylon cord of 1400×2.

In some embodiments, the reinforcing layer 47 may allow the elastomeric material 45 (e.g., PU) of the annular beam 36 to be less stiff, and this may facilitate processability in manufacturing the tire 34. For example, in some embodiments, the modulus of elasticity (e.g., Young's modulus) of the elastomeric material 45 of the annular beam 36 may be no more than 200 MPa, in some cases no more than 150 MPa, in some cases no more than 100 MPa, in some cases no more than 50 MPa, and in some cases even less.

The reinforcing layer 47 may be provided in the annular beam 36 in any suitable way. In this embodiment, the reinforcing layer 47 may be formed as a hoop and placed in the mold before the elastomeric material 45 of the tire 34 is introduced in the mold. As the elastomeric material 45 is distributed within the mold via the centrifugal force generated by the mold's rotation, the reinforcing layer 47 is embedded in that portion of the elastomeric material 45 that forms the annular beam 36.

The reinforcing layer 47 may provide various benefits to the wheel 20ᵢ in various embodiments.

For example, in this embodiment, the reinforcing layer 47 may help to protect the annular beam 36 against cracking. More particularly, in this embodiment, as it reinforces the annular beam 36 proximate to the inner peripheral extent 48 of the annular beam 36 that experiences tensile stresses when the annular beam 36 deflects in use, the reinforcing layer 47 may help the annular beam 36 to better withstand these tensile stresses that could otherwise increase potential for cracking to occur in the elastomeric material 45 of the annular beam 36.

As another example, in this embodiment, the reinforcing layer 47 may help to better manage heat generated within the annular beam 36 as it deforms in use. A thermal conductivity of the material 77 of the reinforcing layer 47 may be greater than a thermal conductivity of the elastomeric material 45 of the annular beam 36, such that the reinforcing layer 47 can better conduct and distribute heat generated within the tire 34 as it deforms in use. This may allow a highest temperature of the elastomeric material 45 to remain lower and therefore allow the wheel 20ᵢ to remain cooler and/or run faster at a given load than if the reinforcing layer 47 was omitted.

More particularly, in this embodiment, a ratio of the thermal conductivity of the material 77 of the reinforcing layer 47 over the thermal conductivity of the elastomeric material 45 of the annular beam 36 may be at least 50, in some cases at least 75, in some cases at least 100, and in some cases even more. For instance, in some embodiments, the thermal conductivity of the material 77 of the reinforcing layer 47 may be at least 10 W/m/° C., in some cases at least 20 W/m/° C., in some cases at least 30 W/m/° C., in some cases at least 40 W/m/° C., and in some cases even more.

A thermal conductivity of a unidirectional composite layer can be calculated by the following equation:

Kᵢ=V_{c}K_{c}+(1−V_{c})Kₘ (10)
Where: Ki=thermal conductivity of the ply in direction i
V_{C}=cable volume fraction in direction i
K_{C}=cable thermal conductivity
K_{M}=matrix thermal conductivity

From Equation (10) the thermal conductivity of a composite is orthotropic; i.e., it is different in different directions. The tire designer can thus tune the composite layer to have the desired conductivity in the circumferential direction (say, the “1” direction) independently of the lateral direction (say, the “2”) direction.

Most elastomers, such as rubber and polyurethane, are good thermal insulators. The inventors have found that even a fairly low cable volume fraction is sufficient to raise the thermal conductivity to a level that adequately evacuates heat. With a steel cable, Equation (10) shows that a cable volume fraction of 0.10 gives a composite layer thermal conductivity of 5.2 W/m/° C. This value, or even a value as low as 2.0 W/m/° C. may be sufficient to improve thermal performance.

In some embodiments, steel may be used as the reinforcing material in both the circumferential and lateral directions. For example, to better dissipate heat and homogenize temperature, a steel cable of 3 strands of 0.28 mm diameter at a pace of 1.8 mm could be used in both the vertical and lateral directions. Such a composite layer has an average thickness of about 1.0 mm, and a steel volume fraction of about 0.10 in both vertical and lateral directions. As previously stated, this yields a thermal conductivity of about 5.2 W/m/° C. for the composite layer.

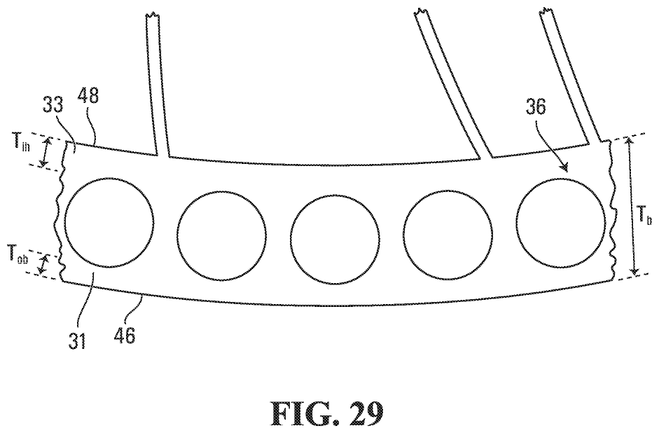

In some embodiments, in addition to or instead of including the reinforcing layer 47, as shown in FIG. 29, a thickness Tb of the annular beam 36 in the radial direction of the wheel 20ᵢ may be increased in order to reinforce the annular beam 36. More particularly, in this embodiment, the inner rim 33 may be increased in thickness. For instance, the inner rim 33 of the annular beam 36 may be thicker than the outer rim 31 of the annular beam 36 in the radial direction of the wheel 20ᵢ. This may help the annular beam 36 to better withstand tensile stresses proximate to the inner peripheral extent 48 of the annular beam 36 when the annular beam 36 deflects in use.

For example, in this embodiment, a ratio of a thickness T_{ib} of the annular beam 36 in the radial direction of the wheel 20ᵢ over the outer diameter D_{W} of the wheel 20ᵢ may be at least 0.05, in some cases at least 0.07, in some cases as least 0.09, and in some cases even more.

As another example, in this embodiment, a ratio of a thickness T_{ib} of the inner rim 33 of the annular beam 36 in the radial direction of the wheel 20ᵢ over a thickness T_{ob} of the outer rim 31 of the annular beam 36 in the radial direction of the wheel 20ᵢ may be at least 1.2, in some cases at least 1.4, in some cases as least 1.6, and in some cases even more.

While in embodiments considered above the wheel 20ᵢ is part of the ATV 10, a wheel constructed according to principles discussed herein may be used as part of other vehicles or other devices in other embodiments.

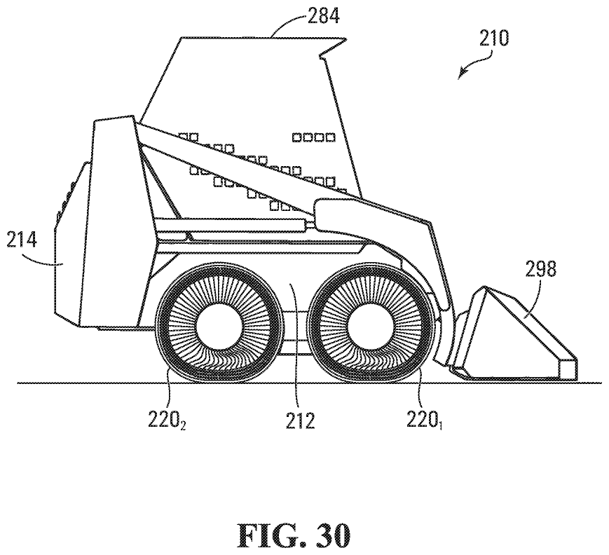

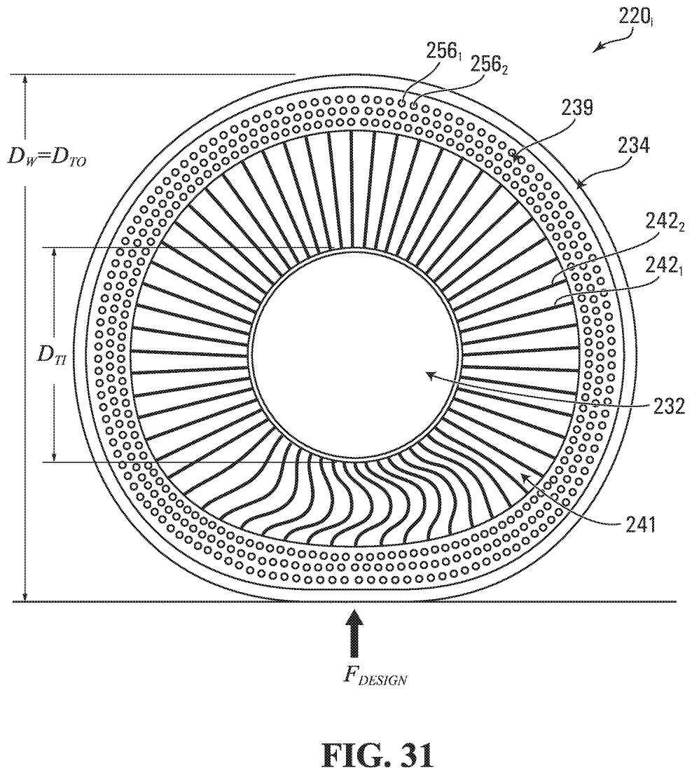

For example, with additional reference to FIGS. 30 and 31, in some embodiments, an industrial vehicle 210 may comprise wheels 220₁-220₄ constructed according to principles discussed herein in respect of the wheel 20ᵢ. The industrial vehicle 210 is a heavy-duty vehicle designed to travel off-road to perform industrial work using a work implement 298. In this embodiment, the industrial vehicle 210 is a construction vehicle. More particularly, in this embodiment, the construction vehicle 210 is a loader (e.g., a skid-steer loader). The construction vehicle 210 may be a bulldozer, a backhoe loader, an excavator, a dump truck, or any other type of construction vehicle in other embodiments.

The construction vehicle 210 comprises a frame 212, a powertrain 214, the wheels 220₁-220₄, the work implement 298, and an operator cabin 284, which enable an operator to move the construction vehicle 210 on the ground and perform construction work using the work implement 298. The operator cabin 284 is where the operator sits and controls the construction vehicle 210. More particularly, the operator cabin 284 comprises a user interface that allows the operator to steer the construction vehicle 210 on the ground and perform construction work using the working implement 298.

The working implement 298 is used to perform construction work. In this embodiment where the construction vehicle 210 is a loader, the working implement 298 is a dozer blade that can be used to push objects and shove soil, debris or other material. In other embodiments, depending on the type of construction vehicle, the working implement 298 may be a backhoe, a bucket, a fork, a grapple, a scraper pan, an auger, a saw, a ripper, a material handling arm, or any other type of construction working implement.

Each wheel 220₁ of the construction vehicle 210 may be constructed according to principles described herein in respect of the wheels 20₁-20₄, notably by comprising a non-pneumatic tire 234 and a hub 232 that may be constructed according to principles described herein in respect of the non-pneumatic tire 34 and the hub 32. The non-pneumatic tire 234 comprises an annular beam 236 and an annular support 241 that may be constructed according principles described herein in respect of the annular beam 36 and the annular support 41. For instance, the annular beam 236 comprises a shear band 239 comprising openings 256₁-256_{B} and the annular support 41 comprises spokes 242₁-242_{J} that may be constructed according to principles described herein in respect of the shear band 39 and the spokes 42₁-42_{T}. In this embodiment, the shear band 239 comprises intermediate rims 251, 253 between an outer rim 231 and an inner rim 233 such that the openings 256₁-256_{N} and interconnecting members 237₁-237_{P} are arranged into three circumferential rows between adjacent ones of the rims 231, 251, 253, 233.

FIG. 31 shows an example of a finite element model of the wheel 220ᵢ, which in this case is an equivalent of a 20.5×25 pneumatic tire used in the construction industry. The wheel 220ᵢ is 1.53 meters in diameter, 0.5 meters in width, and carries a design load of 10 metric tons (10,000 kgf). In this embodiment, an inner diameter of the non-pneumatic tire 34 is 0.62 meters. Like the wheel 20ᵢ described above, in this embodiment, a pneumatic-like zone of deflection is greater than 37% of the wheel's diameter, and a volume fraction V_{fs} of the annular support 241 of the tire 234 is less than about 9%.

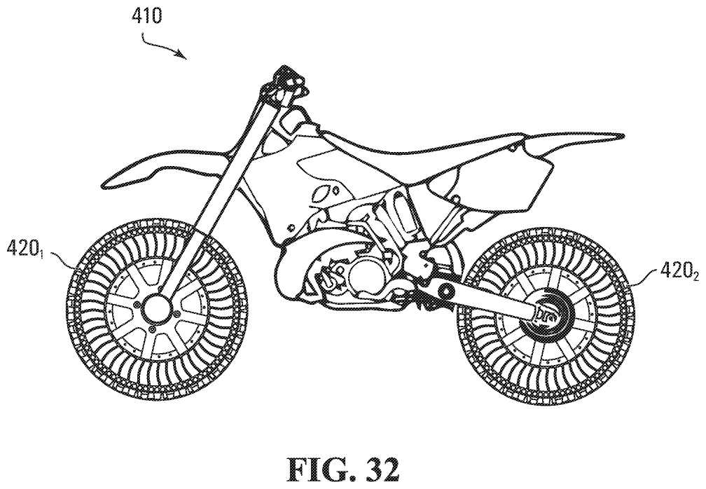

As another example, in some embodiments, with additional reference to FIG. 32, a motorcycle 410 may comprise a front wheel 420₁ and a rear wheel 420₂ constructed according to principles discussed herein in respect of the wheel 20ᵢ.

As another example, in some embodiments, a wheel constructed according to principles discussed herein in respect of the wheel 20ᵢ may be used as part of an agricultural vehicle (e.g., a tractor, a harvester, etc.), a forestry vehicle, a material-handling vehicle, or a military vehicle.

As another example, in some embodiments, a wheel constructed according to principles discussed herein in respect of the wheel 20ᵢ may be used as part of a road vehicle such as an automobile or a truck.

As another example, in some embodiments, a wheel constructed according to principles discussed herein in respect of the wheel 20ᵢ may be used as part of a lawnmower (e.g., a riding lawnmower or a walk-behind lawnmower).

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

In case of any discrepancy, inconsistency, or other difference between terms used herein and terms used in any document incorporated by reference herein, meanings of the terms used herein are to prevail and be used.

Although various embodiments and examples have been presented, this was for the purpose of describing, but not limiting, the invention. Various modifications and enhancements will become apparent to those of ordinary skill in the art and are within the scope of the invention, which is defined by the appended claims.

1. A wheel comprising a non-pneumatic tire, the non-pneumatic tire comprising:
an annular beam configured to deflect at a contact patch of the non-pneumatic tire; and
an annular support disposed radially inwardly of the annular beam and configured to resiliently deform as the wheel engages the ground;
wherein a ratio of a mass of the wheel over an outer diameter of the wheel normalized by a width of the wheel is no more than 0.0005 kg/mm².

2. (canceled)

3. (canceled)

4. (canceled)

5. The wheel of claim 1, wherein the ratio of the mass of the wheel over the outer diameter of the wheel normalized by the width of the wheel is no more than 0.00015 kg/mm².

6. The wheel of claim 1, wherein the ratio of the mass of the wheel over the outer diameter of the wheel normalized by the width of the wheel is no more than 0.00011 kg/mm².

7. (canceled)

8. The wheel of claim 5, wherein a radial stiffness of the wheel is no more than 15 kgf/mm.

9. The wheel of claim 5, wherein a radial stiffness of the wheel is no more than 11 kgf/mm.

10. The wheel of claim 5, wherein a radial stiffness of the wheel is no more than 8 kgf/mm.

11. The wheel of claim 8, wherein: the annular support comprises a plurality of spokes extending from the annular beam to a hub of the wheel; and a ratio of a volume occupied by the spokes over a volume bounded by the annular beam and the hub of the wheel is no more than 15%.

12. (canceled)

13. The wheel of claim 8, wherein: the annular support comprises a plurality of spokes extending from the annular beam to a hub of the wheel; and a ratio of a volume occupied by the spokes over a volume bounded by the annular beam and the hub of the wheel is no more than 10%.

14. (canceled)

15. (canceled)

16. The wheel of claim 8, comprising a hub that is resiliently deformable as the wheel engages the ground.

17. (canceled)

18. The wheel of claim 16, wherein the hub is integral with the non-pneumatic tire.

19. (canceled)

20. (canceled)

21. (canceled)

22. (canceled)

23. (canceled)

24. (canceled)

25. (canceled)

26. (canceled)

27. (canceled)

28. The wheel of claim 8, wherein a ratio of a lateral stiffness of the wheel over the radial stiffness of the wheel is at least 2.

29. (canceled)

30. The wheel of claim 8, wherein a lateral stiffness of the wheel is at least 20 kgf/mm.

31. The wheel of claim 8, wherein a lateral stiffness of the wheel is at least 30 kgf/mm.

32. The wheel of claim 8, wherein a cornering stiffness of the wheel at a design load is at least 40 kgf/deg.

33. The wheel of claim 8, wherein a cornering stiffness of the wheel at a design load is at least 60 kgf/deg.

34. The wheel of claim 8, wherein a cornering stiffness of the wheel at a design load is at least 80 kgf/deg.

35. (canceled)

36. The wheel of claim 8, wherein: a sectional height of the non-pneumatic tire is half of a difference between an outer diameter and an inner diameter of the non-pneumatic tire; and a ratio of the sectional height of the non-pneumatic tire over a width of the non-pneumatic tire is at least 90%.

37. (canceled)

38. (canceled)

39. (canceled)

40. The wheel of claim 1, wherein an inner diameter of the non-pneumatic tire is no more than 40% of an outer diameter of the non-pneumatic tire.

41. (canceled)

42. (canceled)

43. (canceled)

44. The wheel of claim 8, wherein: the annular support comprises a plurality of spokes extending from the annular beam to a hub of the wheel; and each spoke extends substantially completely across the annular beam in a widthwise direction of the wheel.

45. The wheel of claim 32, wherein the wheel comprises a plurality of modules selectively attachable to and detachable from one another.

46. The wheel of claim 45, comprising a hub disposed radially inwardly of the annular support, wherein a first one of the modules comprises the non-pneumatic tire and a second one of the modules comprises the hub.

47. The wheel of claim 46, wherein the hub is replaceable by a different hub.

48. (canceled)

49. (canceled)

50. (canceled)

51. (canceled)

52. (canceled)

53. (canceled)

54. The wheel of claim 8, wherein the annular beam is configured to deflect more by shearing than by bending at the contact patch of the non-pneumatic tire.

55. (canceled)

56. The wheel of claim 54, wherein a ratio of transverse deflection of the annular beam due to shear over transverse deflection of the annular beam due to bending at the center of the contact patch is at least 2.

57. (canceled)

58. (canceled)

59. (canceled)

60. (canceled)

61. (canceled)

62. (canceled)

63. (canceled)

64. (canceled)

65. The wheel of claim 8, wherein the annular support is resiliently deformable such that, when the non-pneumatic tire is loaded, a lower portion of the annular support below an axis of rotation of the non-pneumatic tire is compressed and an upper portion of the annular support above the axis of rotation of the non-pneumatic tire is in tension.

66. (canceled)

67. The wheel of claim 1, wherein the annular beam comprises a plurality of openings distributed in a circumferential direction of the non-pneumatic tire.

68. The wheel of claim 67, wherein each of the openings extends from a first lateral side of the non-pneumatic tire to a second lateral side of the non-pneumatic tire.

69. The wheel of claim 8, wherein the non-pneumatic tire comprises a tread.

70. The wheel of claim 69, wherein the annular beam comprises a first elastomeric material and the tread comprises a second elastomeric material different from the first elastomeric material.

71-105. (canceled)
